(19) United States
(12) Patent Application Publication
(10) Pub. No.: US 2025/0173789 A1
(43) Pub. Date: May 29, 2025

(54) COMPUTER SYSTEM FOR DISTRIBUTED COMPUTER ARCHITECTURES WITH EXCHANGE OF PERPETUAL FUTURES

(71) Applicant: Bullish Global, Grand Cayman (KY)

(72) Inventors: Justin Paul Short, Twickenham (GB); Khaled Al-Hassanieh, Blacksburg, VA (US); Mark Woods, Radford, VA (US); Samuel Hakim, Mid Levels (HK); Ian Temple, Roanoke, VA (US); Shashank Singh Solanki, Singapore (SG); Aditya Gopinath, Causeway Bay (HK); Brian Huang, Richmond, VA (US); Yawei Xia, Jersey City, NJ (US); Maxime Antonie, Singapore (SG); Rutie Zhou, Parsippany, NJ (US); Ashutosh Saxena, Tung Chung (HK); Miti Nopnirapath, Singapore (SG); Hoa Tran, Fort Lee, NJ (US)

(21) Appl. No.: 18/961,931

(22) Filed: Nov. 27, 2024

Related U.S. Application Data
(60) Provisional application No. 63/603,608, filed on Nov. 28, 2023.

(51) Int. Cl. G06Q 40/04

(52) U.S. Cl. CPC G06Q 40/04

(57) ABSTRACT

Embodiments described herein relate to computer systems and methods for derivative or perpetual transactions. The systems and methods involve a plurality of user devices having an interface for the system, the user devices associated with user accounts, each user account having one or more perpetual positions. The systems and methods involve a processing system that includes one or more processors and one or more memories coupled with the one or more processors, the one or more memories storing instructions for a risk engine capable of managing perpetual futures for the trading accounts, each of the trading accounts having its own perpetual positions. The processing system receives input from the interface and generates output for transmission to and display at the interface.

### CROSS REFERENCE TO RELATED APPLICATION(S)

The application claims priority to and the benefit of U.S. provisional patent application No. 63/603,608 entitled COMPUTER SYSTEMS FOR PERPETUAL FEATURES filed Nov. 28, 2023, the entire contents of which is hereby incorporated by reference herein.

### FIELD

The improvements generally relate to the field of electrical computers, computer distributed computer architectures, communication systems, inter-program communication, inter-process communication, executable programs, smart contract code, trading platforms, blockchains, and blockchain infrastructure.

### INTRODUCTION

Distributed computer systems can implement decentralized exchange platforms with code, inter-program communication, inter-process communication and so on. Embodiments described herein relate to improved exchange distributed computer architectures that enable exchange platforms for perpetual futures transactions.

Embodiments described herein relate to distributed computer architectures for an exchange platform that connects to electronic devices to receive commands and requests for peer-to-peer derivative transactions (including e.g. perpetual futures transactions) involving cryptocurrencies and digital assets. Embodiments described herein relate to an exchange platform for peer-to-peer perpetual futures transactions with automated index pricing and de-leveraging. Embodiments described herein relate to an exchange platform for peer-to-peer perpetual futures transactions with a blockchain infrastructure integrating cryptographic and security tools.

### SUMMARY

In accordance with an aspect, there is provided a computer system for derivative transactions such as perpetual futures. The computer system includes a plurality of user devices having an interface for the system and a processing system that includes one or more processors and one or more memories coupled with the one or more processors. The user devices are associated with user accounts and each user account potentially having one or more derivative operations, such as perpetual positions. A perpetual is a contract for futures without an expiry date that references an underlying source of numeric value. Other example derivatives include dated futures, options, and so on.

In an aspect, embodiments described herein provide a computer system for perpetual futures comprising: a plurality of user devices having an interface for the system, the user devices associated with user accounts that are unified trading accounts, each user trading account having code enabling derivative transactions, the code controlling operations for the derivative transactions comprising one or more derivative or perpetual positions, wherein code defines a derivative as a smart contract for futures without an expiry date that references an underlying source of numeric value.

The system as a processing system that includes one or more processors and one or more memories coupled with the one or more processors, the one or more memories storing instructions for a trading engine, a risk engine and a matching engine, the trading engine for managing perpetual trading of the user accounts by detecting permissions for derivative trading that govern operations for a respective user account, the risk engine automatically computing margin and margin requirements for the user account and estimates of expected liquidity cost for unwinding derivative positions, wherein the risk engine triggers automatic unwinding of derivative positions based on an acceptable level of risk or overrides, the matching engine having a hybrid order book integrated with an automated market maker, wherein computed margin and liquidation cost reflects a quality of the assets in the customer account based on determining, for each type of assets in the customer account, a quality rating for a respective type of the asset in the customer account as an assessment of volatility or market risk of the asset in the customer account and an ability to liquidate the asset in the customer account, wherein the computed margin and liquidation cost are adapted to change proportionally with a value of the assets in the customer account;

The processing system has a perpetual package of a perpetual processor, data, the perpetual positions of the user accounts, wherein each of the perpetual positions are associated with margin and margin requirements for the user account and the estimated expected cost of liquidation which are recomputed by the processing system at intervals or as necessary, wherein code automatically controls trading activities for the customer accounts operating in the trading mode using continuously computed estimates of margin and margin requirements for the user account and the estimated expected liquidation cost for the customer accounts.

The processing system has an index manager to compute a numeric value for each underlying that is referenced by a perpetuals contract. The processing system receives input from the interface for an order request for trading a perpetual market to buy or sell a desired quantity of perpetual contracts on the appropriate market, wherein a long position is denoted with a positive number of contracts and a short position is denoted with a negative number of contracts, wherein closing a position is synonymous with holding no perpetual contracts.

The processing system generates output for an account interface of one or more visual elements relating to the perpetual positions of the user accounts for transmission to respective interfaces of the user devices and displays the visual elements relating to the perpetual positions at the interfaces of the user devices.

In some embodiments, the processor sets one or more margin requirements for the customer accounts, and continuously compares margin values for the customer accounts to the margin requirements and expected liquidation cost to automatically evaluate risk for the customer accounts, wherein the processor controls the trading activities for the customer accounts operating in the transaction mode using the one or more margin requirements.

In some embodiments, the processor computes a health indicator for a respective customer account based on the margin, the margin requirements, and the expected liquidation cost, the health indicator corresponding to one or more permitted actions for the customer account, wherein the computer system executes code to control activities for the customer account using the one or more permitted actions corresponding to the health indicator for the customer account.

In some embodiments, upon determining that the margin values for the customer account do not meet the margin requirements for the customer account, the processor updates the one or more permitted actions for the customer account, wherein upon receiving a request for an activity for a customer account, the system verifies the one or more permitted actions corresponding to the health indicator for the customer account before implementing the requested activity, wherein upon determining that the requested activity is not include in the one or more permitted actions corresponding to the health indicator for the customer account, the computer system rejects the request for the activity for the customer account.

In some embodiments, the margin requirements comprise an initial margin requirement, a warning margin requirement, a liquidation margin requirement, a full liquidation margin requirement, a defaulted margin requirement.

In some embodiments, the processor computes margin values for the assets in the customer account used as collateral for the trading activities by discounting a normalized value of all types of assets in the customer account by a haircut reflective of a quality measure of the assets in the customer account, wherein a higher quality asset will have a higher rating and lower haircut, and a lower quality asset will have a lower rating and higher haircut.

In some embodiments, the processor computes margin values for the assets in the customer account as collateral value-haircut, wherein the collateral value is a normalized value of the assets in the customer account and a haircut reflects a quality measure of the assets in the customer account, wherein a higher rating reflects a lower haircut, and a lower rating reflects a higher haircut.

In some embodiments, the processor computes the margin for the customer account as:

$$( collateral value - haircut ) + futures pnl - debt .$$

In some embodiments, index manager creates new indices, edits parameters of the indices, publishes new indices, and freezes the indices.

In some embodiments, the interface has a user interface to display visual elements for the user accounts and the perpetual positions, wherein the user interface has a perpetual position blotter, portfolio pages, and historical pages.

In some embodiments, the interface has an application programming interface for the perpetual positions of the user accounts, wherein the application programming interface has a perpetual position API managing data about the perpetual positions for the user accounts, trading account configurations, and a ticker.

In some embodiments, the processing system nets out each of the perpetual positions for each of the user accounts.

In some embodiments, the processor system has a liquidation component to automatically unwind the derivative positions in the trading account.

In some embodiments, the underlying is an underlying asset.

In some embodiments, automated market maker is configured to discretize long and short positions; hold consolidated perpetual positions; and distribute the perpetual positions to components of the system.

In another aspect, there is provided a computer implemented method for perpetual futures comprising: managing perpetual trading of the user accounts by detecting permissions for derivative trading that govern operations for a respective user account, a risk engine automatically computing margin and margin requirements for the user account and estimates of expected liquidity cost for unwinding derivative positions, wherein the risk engine triggers automatic unwinding of derivative positions based on an acceptable level of risk or overrides, wherein computed margin and liquidation cost reflects a quality of the assets in the customer account based on determining, for each type of assets in the customer account, a quality rating for a respective type of the asset in the customer account as an assessment of volatility or market risk of the asset in the customer account and an ability to liquidate the asset in the customer account; recomputing, for each of the perpetual positions, margin and margin requirements for the user account and the estimated expected cost of liquidation which are by the processing system at intervals or as necessary, wherein code automatically controls trading activities for the customer accounts operating in the trading mode using continuously computed estimates of margin and margin requirements for the user account and the estimated expected liquidation cost for the customer accounts; receiving input from the interface for an order request for trading a perpetual market to buy or sell a desired quantity of perpetual contracts on the appropriate market, wherein a long position is denoted with a positive number of contracts and a short position is denoted with a negative number of contracts, wherein closing a position is synonymous with holding no perpetual contracts; executing code controlling operations for the derivative transactions comprising one or more derivative or perpetual positions, wherein code defines a derivative as a smart contract for futures without an expiry date that references an underlying source of numeric value; and generating output for an account interface of one or more visual elements relating to the perpetual positions of the user accounts for transmission to respective interfaces of the user devices and displays the visual elements relating to the perpetual positions at the interfaces of the user devices; wherein the margin requirements comprise an initial margin requirement, a warning margin requirement, a liquidation margin requirement, a full liquidation margin requirement, a defaulted margin requirement.

In some embodiments, the method involves setting one or more margin requirements for the customer accounts, and continuously comparing, using the processing system, margin values for the customer accounts to the margin requirements and expected liquidation cost to automatically evaluate risk for the customer accounts, wherein the processor controlling the trading activities for the customer accounts operating in the transaction mode using the one or more margin requirements.

In some embodiments, the method involves computing a health indicator for generating visual elements at an interface corresponding to a respective customer account based on the margin, the margin requirements, and the expected liquidation cost, the health indicator corresponding to one or more permitted actions for the customer account, ‘wherein the computer system executes code to control activities for the customer account using the one or more permitted actions corresponding to the health indicator for the customer account.

In some embodiments, the method involves, upon determining that the margin values for the customer account do not meet the margin requirements for the customer account, updating the one or more permitted actions for the customer account, wherein upon receiving a request for an activity for a customer account, the system verifies the one or more permitted actions corresponding to the health indicator for the customer account before implementing the requested activity, wherein upon determining that the requested activity is not included in the one or more permitted actions corresponding to the health indicator for the customer account, rejecting the request for the activity for the customer account.

In another aspect, there is provided a non-transitory machine readable medium having stored thereon a plurality of instructions that, when executed by at least one computing device, cause the at least one computing device to perform the method for perpetual futures comprising: managing perpetual trading of the user accounts by detecting permissions for derivative trading that govern operations for a respective user account, a risk engine automatically computing margin and margin requirements for the user account and estimates of expected liquidity cost for unwinding derivative positions, wherein the risk engine triggers automatic unwinding of derivative positions based on an acceptable level of risk or overrides, wherein computed margin and liquidation cost reflects a quality of the assets in the customer account based on determining, for each type of assets in the customer account, a quality rating for a respective type of the asset in the customer account as an assessment of volatility or market risk of the asset in the customer account and an ability to liquidate the asset in the customer account; recomputing, for each of the perpetual positions, margin and margin requirements for the user account and the estimated expected cost of liquidation which are by the processing system at intervals or as necessary, wherein code automatically controls trading activities for the customer accounts operating in the trading mode using continuously computed estimates of margin and margin requirements for the user account and the estimated expected liquidation cost for the customer accounts; receiving input from the interface for an order request for trading a perpetual market to buy or sell a desired quantity of perpetual contracts on the appropriate market, wherein a long position is denoted with a positive number of contracts and a short position is denoted with a negative number of contracts, wherein closing a position is synonymous with holding no perpetual contracts; executing code controlling operations for the derivative transactions comprising one or more derivative or perpetual positions, wherein code defines a derivative as a smart contract for futures without an expiry date that references an underlying source of numeric value; and generating output for an account interface of one or more visual elements relating to the perpetual positions of the user accounts for transmission to respective interfaces of the user devices and displays the visual elements relating to the perpetual positions at the interfaces of the user devices.

In some embodiments, one or more memories store instructions for a risk engine for managing perpetual trading of the user accounts by tracking collateral value and automatically liquidating collateral based on an acceptable level of risk. The system has a matching engine having a hybrid order book integrating a central limit order book and an automated market maker. The processing system has a perpetual package of a perpetual processor, data, and the perpetual positions of the user accounts. Each of the perpetual positions are backed by collateral recomputed by the processing system at intervals or as necessary. The processing system has an index manager to compute a numeric value for each underlying that is referenced by a perpetuals contract. The processing system receives input from the interface for an order request for trading a perpetual market to buy or sell a desired quantity of perpetual contracts on the appropriate market. A long position is denoted with a positive number of contracts and a short position is denoted with a negative number of contracts. Closing a position is synonymous with holding no perpetual contracts. The processing system generates output relating to the perpetual positions of the user accounts for transmission to interfaces of the user devices and displays visual elements relating to the perpetual positions at the interfaces of the user devices. A communication bus with a sequencer routes data and commands to the risk engine.

In some embodiments, the index manager creates new indices, edits parameters of the indices, publishes new indices, and freezes the indices.

In some embodiments, the interface has a user interface to display visual elements for the user accounts and the perpetual positions. The user interface has a perpetual position blotter, portfolio pages, and historical pages.

In some embodiments, the interface has an application programming interface for the perpetual positions of the user accounts, wherein the application programming interface has a perpetual position API managing data about the perpetual positions for the user accounts, trading account configurations, and a ticker.

In some embodiments, the processing system nets out each of the perpetual positions for each of the user accounts.

In some embodiments, the processor system has a liquidation dealer engine.

In some embodiments, the underlying source is a numeric value.

In some embodiments, the automated market maker is configured to discretize long and short positions, hold consolidated perpetual positions, and distribute the perpetual positions to components of the system.

In accordance with an aspect, there is provided a computer implemented method for derivative transactions such as dated futures, options, perpetual futures, and so on. For example, the method includes providing a processing system with an engine for managing perpetual trading of user accounts by tracking collateral value and automatically liquidating collateral based on an acceptable level of risk, computing, by the processing system, collateral for the perpetual positions of the user accounts, computing a numeric value for each underlying that is referenced by a perpetuals contract, receiving input from an interface for an order request for trading a perpetual market to buy or sell a desired quantity of perpetual contracts on the appropriate market, and generating output relating to the perpetual positions of the user accounts for transmission to interfaces of the user devices and display of visual elements relating to the perpetual positions at the interfaces of the user devices. Each user account has one or more perpetual positions. A perpetual is a contract for futures without an expiry date that references an underlying source of numeric value. The risk engine has a matching engine having a central limit order book and an automated market maker. Each of the perpetual positions are backed by the collateral, and recomputing, by the processing system, the collateral at intervals or as necessary. A long position is denoted with a positive number of contracts and a short position is denoted with a negative number of contracts. A closing a position is synonymous with holding no perpetual contracts.

In accordance with an aspect, there is provided a non-transitory machine readable medium having stored thereon a plurality of instructions that, when executed by at least one computing device, cause the at least one computing device to perform the method for perpetual futures. The method includes providing a processing system with an engine for managing perpetual trading of user accounts by tracking collateral value and automatically liquidating collateral based on an acceptable level of risk, computing, by the processing system, collateral for the perpetual positions of the user accounts, computing a numeric value for each underlying that is referenced by a perpetuals contract, receiving input from an interface for an order request for trading a perpetual market to buy or sell a desired quantity of perpetual contracts on the appropriate market, and generating output relating to the perpetual positions of the user accounts for transmission to interfaces of the user devices and display of visual elements relating to the perpetual positions at the interfaces of the user devices. The risk engine has a matching engine having a central limit order book and an automated market maker. Each user account has one or more perpetual positions. A perpetual is a contract for futures without an expiry date that references an underlying source of numeric value. Each of the perpetual positions are backed by the collateral, and recomputing, by the processing system, the collateral at intervals or as necessary. A long position is denoted with a positive number of contracts and a short position is denoted with a negative number of contracts. A closing a position is synonymous with holding no perpetual contracts.

Many further features and combinations thereof concerning embodiments described herein will appear to those skilled in the art following a reading of the instant disclosure.

### DESCRIPTION OF THE FIGURES

In the figures,

FIG. 1A shows a schematic diagram of a distributed computer system for perpetual futures, according to some embodiments.

FIG. 1B shows a schematic diagram of a distributed computer system for perpetual futures, according to some embodiments.

FIG. 2 shows a schematic diagram of a dispatcher package, according to some embodiments.

FIG. 3 shows a schematic diagram of a matcher package, according to some embodiments.

FIG. 4 shows a schematic diagram of a market-maker package, according to some embodiments.

FIG. 5 shows a schematic diagram of a marginer package, according to some embodiments.

FIG. 6 shows a schematic diagram of an accountant package, according to some embodiments.

FIG. 7 shows a schematic diagram of a config package, according to some embodiments.

FIG. 8 shows a schematic diagram of a price processor package, according to some embodiments.

FIG. 9 is a schematic diagram of computing a device, exemplary of an embodiment.

FIG. 10 shows a schematic diagram of a distributed computer system for perpetual futures, according to some embodiments.

FIG. 11 illustrates an example method for perpetual futures, according to some embodiments.

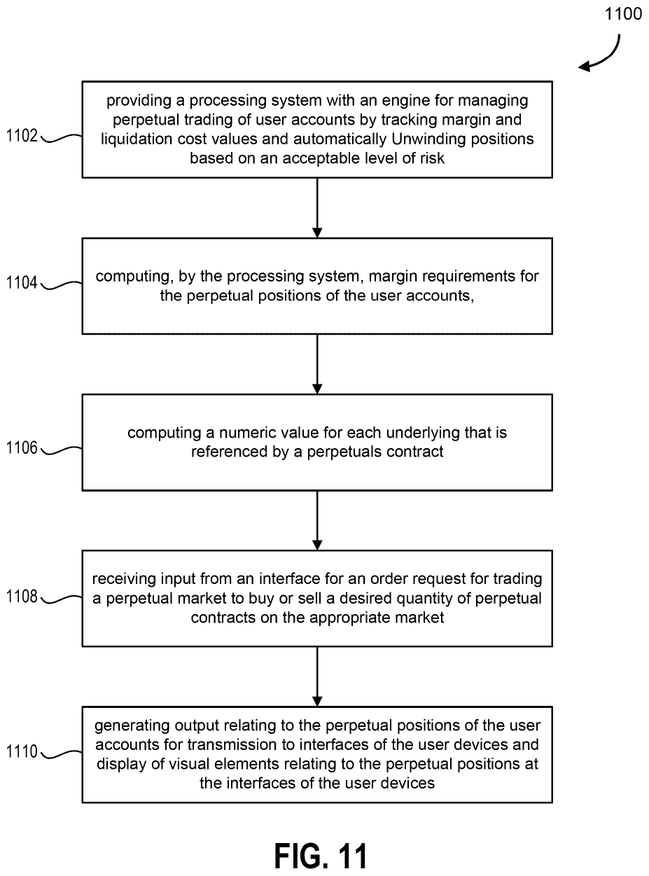

### DETAILED DESCRIPTION

Embodiments described herein provide systems and methods for unified trading accounts enabling derivative transactions, such as perpetual futures transactions, using code (e.g. smart contracts) executing on a decentralized or distributed exchange platform for trading (e.g. digital assets) in a regulated environment. Futures are derivatives that can be defined by smart contract code that tracks the expected future price of a particular asset at a specific date and time called the expiry. Derivative markets allow buy or sell contracts whose price derives from an underlying calculation or value. Perpetual futures are futures without an expiry. That is, perpetual futures are derivatives that can be defined by smart contract code that tracks the expected future price of a particular asset (e.g. digital asset). Like other futures, the price for perpetual futures is independent but correlated. Embodiments described herein relate to pricing for derivative transactions such as perpetual futures. Embodiments described herein relate to an exchange platform implemented by distributed computer architectures for derivative transactions such as perpetual future transactions.

Embodiments described herein relate to distributed computer systems that can implement decentralized exchange platforms. Embodiments described herein relate to an exchange platform that connects to electronic devices to receive commands and requests for peer-to-peer trading in derivatives, such as perpetual futures transactions, involving cryptocurrencies and digital assets.

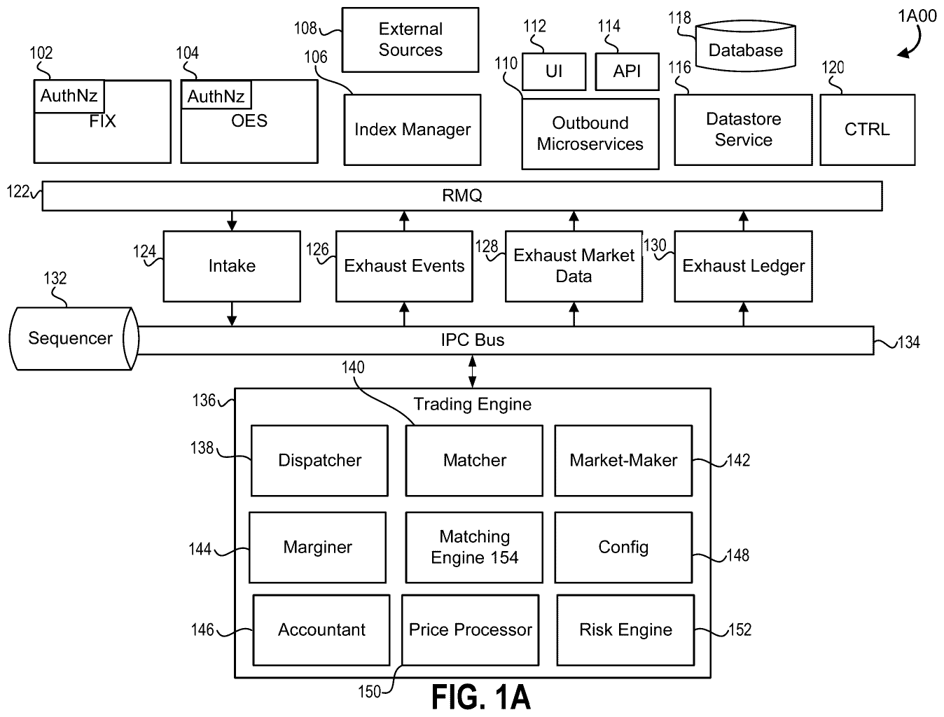

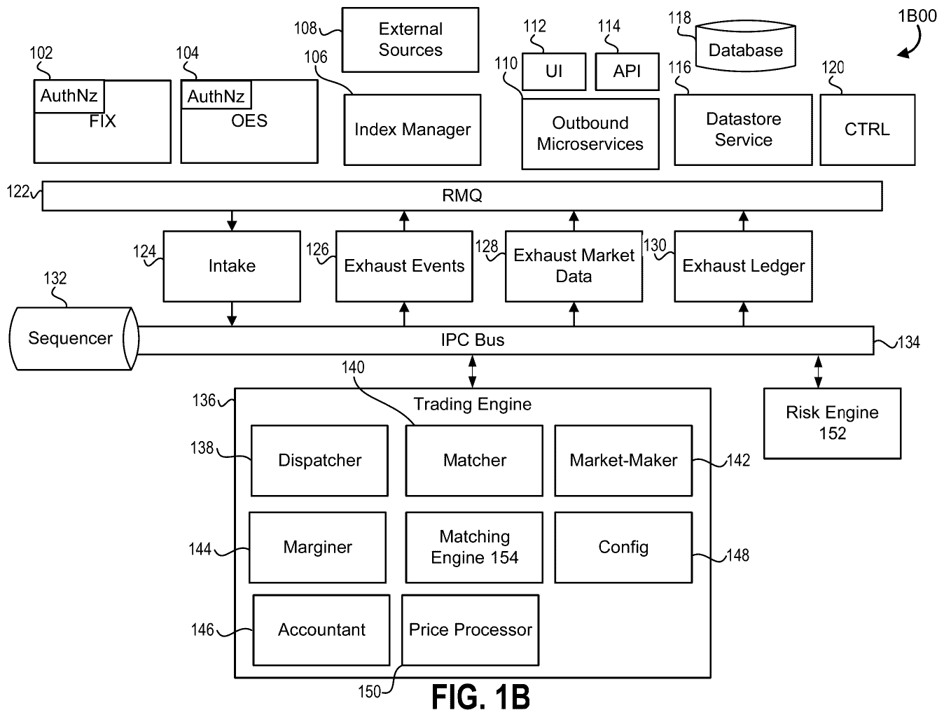

FIG. 1A shows an example schematic diagram of a distributed computer system 100 for perpetual futures. The distributed computer system 100 can be referred to as an exchange platform herein.

The distributed computer system 100 provides for peer-to-peer perpetual futures transactions with automated index pricing and de-leveraging. The distributed computer system 100 can have a blockchain infrastructure integrating cryptographic and security tools.

The exchange platform 100 can support trading in derivatives, such as perpetual futures contracts (“perpetuals” or “perpetuals contracts”) for eligible users and activated accounts. Perpetuals are a type of futures contract without an expiry date, and perpetuals can reference the prices of select digital assets, initially quoted in one or more currencies of one or more markets (“Underlying Markets”). Embodiments described herein provide systems and methods for trading in derivatives, such as perpetual futures transactions, using code executing on a decentralized or distributed exchange platform for trading assets in a regulated environment. For example, perpetuals can reference the price of select digital assets initially quoted in USDC or other cryptocurrency in view of regulatory requirements.

Perpetuals can provide increased capital efficiency for customers trading on the exchange platform 100 and may enable new user segments. They may also reduce the time required to list a perpetual referencing a new digital asset, as there may be no need to keep either of the underlying assets in custody. Perpetuals may therefore provide users with greater opportunities to trade.

Perpetuals trading may involve the use of leverage. Platform 100 can compute margin and margin requirements in relation to perpetuals trading. For example, platform 100 may use a risk engine 152 to track or consider market impact of liquidating collateral positions or collateral value and may automatically unwind derivative positions, if deemed necessary to reduce the chances of that trading account reaching an unacceptable level of risk. Platform 100 can compute margin and margin requirements for governing trading activities. Users can use the same collateral for simultaneous trading of both perpetuals and leveraged spot trading (e.g., via borrowing), while remaining within defined risk limits.

The exchange platform 100 has a trading engine 136 and unified trading accounts that enable trading in spot, margin, and derivatives, such as perpetuals. The platform 100 also has a risk engine 152 for computing risk measures associated with the unified trading accounts and determining liquidity risks and/or the cost of liquidity as part of the risk (e.g. cost of unwinding derivative positions). FIG. 1A shows an example schematic diagram of exchange platform 100 for perpetual futures that includes a trading engine 136 with a risk engine 152 and a matching engine 154. FIG. 1B shows another example schematic diagram of exchange platform 100 for perpetual futures with the trading engine in communication with a risk engine 152 via communication bus 134.

The exchange platform 100 is configured to consider the market impact of liquidating collateral positions (e.g. for something more liquid). The exchange platform 100 can compute more accurate (and safe) risk adjusted values for he collateral by also considering the liquidation add on (e.g. cost of unwinding derivative positions). The allow exchange platform 100 can also have overrides/minimums for lower quality assets that would otherwise be untradeable.

Embodiments described herein can use a portfolio risk estimation process in relation to derivatives and perpetual contracts to estimate the liquidation risk that involves liquidity costs (e.g. unwinding of potential derivative positions). Platform 100 may not offer a spot market for some perpetual contracts, for example. Platform 100 may implement trading activities based on collateral. For example, a trading account may be associated with collateral to permit derivatives trading or trade on margin. This collateral can be in different forms (e.g. different types currencies and cryptocurrencies). Platform 100 can compute a price for the collateral used to support trading activities. There is a market impact when assets are sold so that market price is not an accurate price for the collateral. For example, in a stress scenario the assets may not be sold at a lower price than the market price. Exchange platform 100 can apply a model to estimate or compute the market impact and accurately determine the value of collateral. The market impact model can consider historical data to consider worst case scenarios or stress scenarios to determine the value of collateral. The market impact model can e.g. simulate pushing down the market to model the impact on the market of selling the collateral. For example, the model can use historical data to see how much a previous trade impacts the market. Generally, a stress scenario results in a “discount” on the price or value of collateral. Exchange platform 100 can use the market impact model to generate different bands or tiers of discounts to determine the price or estimate the value of the collateral. The model is not limited to historical data. For example, the model can specifically allow overrides/minimums for lower quality assets that would otherwise be untradeable.

Consistent with prudent risk management and practices of regulated exchanges, system 100 can compute estimates of liquidation risk and apply a rating (which may be referred to as a ‘haircut’) to customers' accounts (including subaccounts) of digital assets (“assets”) to reflect the quality of the assets. In practice, for example, a lower rating (e.g. large haircut) can indicate a relatively lower quality asset. System 100 detects when a customer account has permissions for trading derivatives such as perpetuals and computes associated estimates of liquidation risk for trading activities. System 100 computes estimates of liquidation risk for the account. A process for collateral valuation is provided in U.S. patent application Ser. No. 18/793,679, entitled COMPUTER SYSTEM FOR ON-DEMAND MARGIN BORROWING AND LENDING, filed 2 Aug. 2024, which is incorporated herein by reference. The improved process for collateral valuation better assesses the volatility or market risk of an asset and the ability to liquidate such asset to establish prudent haircuts that adapt to (increase) as the amount of asset deposited as collateral increases. In summary, higher quality (i.e. lower volatility, higher ability to liquidate) assets will continue to receive a higher collateral rating (i.e. lower haircut). Lower quality assets will receive a lower collateral rating that more sharply decreases (higher haircut) as the amount of the asset is deposited (i.e. less recognized value). Smaller collateral positions will receive a higher collateral rating than larger positions to reflect liquidation capacity.

The approach for collateral valuation involves analysis of historical trading data on the exchange platform 100 to determine the appropriate ratings for the quality of each asset that is accepted as collateral for trading activities. It analyzes the effect on collateral value (in particular the amount of collateral value decretion or drawdown) in the event that liquidation is required across a range of scenarios and sizes. In short, it is a statistical approach that attempts to cluster assets (e.g. cryptocurrencies, currencies or coins) into tiers and bands so that for different coins with different sizes, platform 100 defines an associated collateral rating for them. Regarding its integration with the margin process, the margin is calculated as: margin=(collateral-haircut)+futures pnl-debt. The collateral valuation process can impact the (collateral-haircut) component. For all the coins users post as collateral in their accounts, exchange platform 100 can use the collateral rating to recalculate the dollar amount for each coin. This dollar amount is discounted compared to the spot value of the coins and will be included as margin in the account. The collateral rating may correspond to a band or tier.

The “haircut” for the collateral valuation process can be similar to the market impact computed by exchange platform 100, or how much of the value will be lost e.g. in the stress scenario. For perpetuals, exchange platform 100 may not use the collateral valuation process to calculate collateral ratings for derivative and perpetual instruments. Instead, exchange platform 100 can utilize the collateral valuation process as an initial tool to estimate the liquidation risk when considering the unwinding of potential derivative positions. Platform 100 may create “incubator” tiers that align with risk limits or requirements. These tiers can apply to perpetual contracts without an underlying spot market on the exchange platform 100. The tiers can be expanded to additional tiers which can include perpetual contracts and some other spot assets. Please refer to the following table for an example of tiers:

| | Collateral Tiers | | Notional ($) | Rating |
|---|---|---|---|---|
| Index | USD | | 0-1,000,000,000 | 100% |
| Perps | USDC | | 0-20,000,000 | 100% |
| | | | 20,000,000-50,000,000 | 91% |
| | | | 50,000,000-80,000,000 | 81% |
| | | | 80,000,000-100,000,000 | 74% |
| | | | 100,000,000-120,000,000 | 45% |
| | BTC | | 0-100,000 | 100% |
| | ETH | | 100,000-9,000,000 | 98% |
| | WBTC | | 9,000,000-20,000,000 | 85% |
| | WEETH | | 20,000,000-30,000,000 | 65% |
| | | | 30,000,000-40,000,000 | 50% |
| | USDT | | 0-1,000,000 | 100% |
| | | | 1,000,000-5,000,000 | 90% |
| | | | 5,000,000-7,000,000 | 74% |
| | | | 7,000,000-10,000,000 | 61% |
| | | | 10,000,000-12,000,000 | 45% |
| | XRP | | 0-60,000 | 100% |
| | | | 60,000-1,000,000 | 90% |
| | | | 1,000,000-2,000,000 | 80% |
| | | | 2,000,000-3,000,000 | 60% |
| | | | 3,000,000-4,000,000 | 40% |
| | SOL | | 0-10,000 | 97% |
| | AAVE | | 10,000-200,000 | 90% |
| | UNI | | 200,000-300,000 | 80% |
| | | | 300,000-400,000 | 65% |
| | | | 400,000-500,000 | 55% |
| | AVAX | MATIC | 0-10,000 | 97% |
| | CRV | POL | 10,000-100,000 | 85% |
| | DOGE | | 100,000-125,000 | 64% |
| | LINK | | 125,000-150,000 | 58% |
| | LTC | | 150,000-200,000 | 43% |
| | PYUSD | | 0-50,000 | 100% |
| | EUR | | 50,000-200,000 | 91% |
| | EURC | | 200,000-250,000 | 84% |
| | | | 250,000-300,000 | 72% |
| | | | 300,000-400,000 | 65% |
| | CD20 | | 0-500,000 | 95% |
| | | | 500,000-1,500,000 | 88% |
| | | | 1,500,000-3,000,000 | 40% |
| Perp | ADA | PEPE1M | 0-100,000 | 95% |
| Only | AEVO | PYTH | 100,000-300,000 | 88% |
| | APT | RENDER | 300,000-600,000 | 40% |
| | ARB | SEI | | |
| | ATOM | SHIB1M | | |
| | ETC | STX | | |
| | FET | SUI | | |
| | FIL | TIA | | |
| | INJ | WIF | | |
| | OP | WLD | | |
| | ORDI | XLM | | |
| IIliquid | APE | LRC | 0-100,000 | 90% |
| Spot + | BCH | MANA | 100,000-300,000 | 68% |
| Perp | CHZ | NEAR | 300,000-600,000 | 25% |
| | DOT | SAND | | |
| | EOS | SUSHI | | |
| | FTM | TRX | | |
| | GRT | | | |
| | GALA | | (see above) | |
| | PAXG | | | |
| IIliquid | ENS | | (see above) | |
| Spot | ETHFI | | | |
| Only | TON | | | |

Without Risk Appetite Adjustment

| Notional ($) | Rating |
|---|---|
| 0-1,000 | 95% |
| 1,000-20,000 | 90% |
| 20,000-30,000 | 73% |
| 30,000-40,000 | 60% |
| 40,000-60,000 | 50% |
| 0-100 | 75% |
| 100-10,000 | 50% |
| 10,000-15,000 | 20% |
| 15,000-20,000 | 15% |
| 20,000-30,000 | 5% |
| N/A | N/A |

Exchange platform 100 can detect permissions that enable perpetual trading or an activated trading mode that governs operations for a respective user account, automatically computing estimates of liquidation risk and automatically unwinding derivative positions based on an acceptable level of risk. The platform 100 has a matching engine (or matcher) 140 having a hybrid order book integrated with an automated market maker 142. The computed estimates of liquidation risk reflects a quality of the assets in the customer account based on a statistical analysis of historical trading data to determine, for each type of assets in the customer account, a quality rating for a respective type of the asset in the customer account as an assessment of volatility or market risk of the asset in the customer account and an ability to liquidate the asset in the customer account. The computed estimates of liquidation risk are adapted to change proportionally with a value of the assets in the customer account. The estimates of liquidation risk can also be referred to as the expected cost of liquidity. Exchange platform 100 can consider the market impact of liquidating collateral positions (e.g. for assets that are more liquid) and including an add on for the cost of liquidity provides a more accurate (and safe) risk adjusted value for the collateral. Exchange platform 100 can extend collateral valuations to liquidating assets in a (stress) scenario for cash, for example. The computed estimates of risk can include the liquidation add on (e.g. the cost of unwinding derivative positions). Accordingly, liquidation as used herein can refer to unwinding derivative positions or perpetuals positions.

Exchange platform 100 for perpetual futures connects to plurality of user devices having an interface for the platform 100. The user devices are associated with user accounts that are unified trading accounts. Each user trading account has code enabling derivative transactions. The code controls operations for the derivative transactions with one or more derivative or perpetual positions. The code defines a derivative as a smart contract for futures without an expiry date that references an underlying source of numeric value.

The platform 100 has a trading engine 136 for derivatives trading for the unified trading accounts, a risk engine 152, and a matching engine 154. The trading engine 136 and/or risk engine 152 manages perpetual trading of the user accounts and detects permissions for derivative trading that govern operations for a respective user account. The platform 100 can permit trades on a derivative or perpetual market based on permissions on the trading accounts that are linked to users, for example. The platform 100 can codify rules to meet regulatory requirements. For example, derivatives may need to be settled in a digital asset so as a result platform 100 needs to convert to a settlement currency. The risk engine 152 automatically computes margin and margin requirements for the user account and estimates an expected cost of liquidation, and automatically unwinds derivative positions based on an acceptable level of risk. Reference to leverage herein and values associated therewith may refer to margin and margin requirements.

In some embodiments, platform 100 can compute a health indicator for the account based on the margin and margin requirements. Example margin requirements include: initial margin requirement, warning margin requirement, liquidation margin requirement, full liquidation margin requirement, defaulted margin requirement. That is, platform 100 can determine or estimate health trading activities or the health of a trading account based on the margin value and margin requirements. The margin values can map to different health levels. When the platform 100 determines a low health level (e.g. a danger zone) then it can trigger actions, such as unwinding perpetual positions. The health levels can be presented as visual elements in an interface to indicate the health of the trading account. The health levels or indicators can control what actions or activities an account can take at various margin levels. Example health indicators include: healthy, monitor, caution, danger, critical, and suspended.

In some embodiments, the exchange platform 100 uses historical data to compute margin, margin requirements, and the expected cost of liquidation. For example, the exchange platform 100 computes the expected cost of liquidation based on historical trading volumes. In some embodiments, the exchange platform 100 sets overrides for the most illiquid markets so that they remain tradeable. For example, for some assets or markets, exchange platform 100 cannot gather historical data on illiquid markets so exchange platform 100 may still permit these trading activities to gather more data. In some embodiments, the exchange platform 100 assigns or assumes a minimum liquidity so that even if it has not been observed as historical data it is assumed risk and is permitted.

As noted, the risk engine 152 automatically computes margin and margin requirements for the user account and estimates an expected cost of liquidation, and automatically unwinds derivative positions based on an acceptable level of risk. Margin requirements relate to the chance of worst case scenario, and the liquidity cost is a liquidity add on (e.g. how much is needed to get out of the worst case scenario). The liquidation cost is the cost if you have to liquidate, and can be considered an add-on. A matching engine 154 has a hybrid order book integrated with an automated market maker. The margin, margin requirements, and computed estimates of liquidation cost reflects a quality of the assets in the customer account based on determining, for each type of assets in the customer account, a quality rating for a respective type of the asset in the customer account as an assessment of volatility or market risk of the asset in the customer account and an ability to liquidate the asset in the customer account, wherein the computed estimates of liquidation risk are adapted to change proportionally with a value of the assets in the customer account.

The platform 100 also has a perpetual package of a perpetual processor, data, the perpetual positions of the user accounts. Each of the perpetual positions are associated with margin and margin requirements for the user account and the estimated expected cost of liquidation which are recomputed by the processing system at intervals or as necessary. The code automatically controls trading activities for the customer accounts operating in the trading mode using continuously computed estimates of margin and margin requirements for the user account and the estimated expected cost of liquidation for the customer accounts.

The platform 100 has an index manager 106 to compute a numeric value for each underlying that is referenced by a perpetuals contract. The platform 100 receives input from the interface for an order request for trading a perpetual market to buy or sell a desired quantity of perpetual contracts on the appropriate market, wherein a long position is denoted with a positive number of contracts and a short position is denoted with a negative number of contracts, wherein closing a position is synonymous with holding no perpetual contracts.

The platform 100 generates output for an account interface of one or more visual elements relating to the perpetual positions of the user accounts for transmission to respective interfaces of the user devices and displays the visual elements relating to the perpetual positions at the interfaces of the user devices.

The platform 100 can use numerous considerations and approaches for parameters of the methodology for computing collateral valuations.

Liquidation Time Period parameter: analysis by the platform 100 is based on a 6 hour maximum liquidation time frame. This parameter is based on the likely maximum time period in which assets could be liquidated by the platform 100 reliably without causing market disruption and within acceptable values. Where the posted amount exceeds such defined maximum amount, such amount will receive a 100% haircut (i.e., no recognized value) by the system 100.

Lookback Period parameter: analysis by the platform 100 applies a 6 month recent data approach to (a) account for changes in AMM strategy and (b) consider recent trading volume to reflect current market sentiment. In addition, a historical material stress event is also considered by the platform 100 to account for extreme but plausible volatility that may impact and/or be beyond quantitative results of the analysis.

Confidence Interval parameter: analysis by the platform 100 applies a min. 99% confidence interval (CI), thereby applying the first-percentile worst-case scenario return to determine the haircut for defined notional amounts. This analysis by the platform 100 contemplates an extreme, worst-case scenario where the risk waterfall has failed (i.e., corrective actions are not successful or not able to perform due to a system outage), leading to the need to fully liquidate an entire collateral portfolio by the system 100. Applying a 99% Cl, indicates that 99% of the time, the actual market impact (i.e., haircut) will be less than the value given.

Trading Volume/Concentration parameter: analysis by the platform 100 conservatively assumes that during the modeled liquidation, such account will be 50% of the trading volume at the exchange, while the platform 100 is liquidating the positions. This analysis seeks to model the worst-case the platform 100 calculates that the two largest customers of the exchange are being liquidated simultaneously and further that such accounts account for approximately 50% of total volume traded over the liquidation period.

Stress Event parameter: analysis by the platform 100 considers an extreme but plausible market event, whereby a “worst-case 24h” scenario is incorporated into the system 100 dataset (e.g., exceeds market moves in the selected data set). For this scenario, the most significant one-day drawdown of Bitcoin, Nov. 9, 2022, corresponding to the FTX bankruptcy, can be selected. When the system 100 doesn't have trading data from a given period, such at the period corresponding to the FTX bankruptcy, historical data from another exchange (e.g., Coinbase) can be utilized by the platform 100 as a benchmark enabling the system 100 to simulate the relative price changes and volume distribution that would likely occur on the system 100. The methodology used by the platform 100 inserts this scenario (market move) into the 6 month look-back period.

New Assets parameter: if there is no available historical data on the platform 100 for a new asset, but there exists an liquidity arrangement active for the system 100, an AMM-based approach will be utilized by the platform 100 to predict trading volumes and establish appropriate tiers/bands with further qualitative considerations until such time that sufficient historical trading data is available to perform the full margin collateralization analysis. For initial coin offerings (ICOs) and other assets where no trading data available for the system 100 and no arrangements are in place that provide confidence on trading volumes, the system 100 would assig a material haircut (e.g., near to or 100%, materially low band notional value) to such assets until there is sufficient basis to provide greater recognition.

Data Reference parameter: liquidation of non-stable assets (e.g., coins) are calculated by the system 100 to take place in the most liquid AMM pool—for example, BTC liquidations take place in BTCUSDC pool. Liquidations of stable coins are calculated by the system 100 to take place in a combined AMM pools where such stablecoin acts as the quote currency in the pool—for example, USDC liquidations by the system 100 can take place simultaneously across BTCUSDC, ETHUSDC and other USDC associated AMM pools.

The analysis by the platform 100 utilizes asset prices and trading volume sourced from different sources, such as Coin Metrics (e.g. accessed via the platform 100 API). The resulting data sets are incorporated in the platform 100 based on the methodology and parameters to the quantitative risk approach commonly referred to as, R, as the analytical approach for risk assessment.

In some embodiments, the exchange platform 100 can include a FIX 102, Order Entry Services 104, Index Manager 106 (which may also be referred to as the Index Price Service), and External Sources 108, Outbound Microservices 110 including a user interface (UI) 112 and application programming interface (API) 114, datastore services 116 with database 118, and a CTRL 120. The initial input sources can include the FIX 102 and Order Entry Services 104, and external sources such as exchanges (e.g., Binance and Coinbase). The initial input sources can also include authentication and authorization services. The input sources provide input data and commands to the Index Manager 106 (or other index price service) and the CTRL 120 which are then provided to the RMQ 122. The intake 124 inputs into the sequencer 132 which then inputs into the Engine 136. The sequencer 132 can add an identifier to packets and can also include timestamps. The outputs to the RMQ 122 include Exhaust events 126, Exhaust Market Data 128, and Exhaust Ledger 130. From the RMQ 128 the Outbound Microservices 110 output to UI 112 and API 114, and the Datastore Service 116 outputs to database 118.

The Index Manager 106 can get price feeds either via a communication interface (e.g. REST or Websockets) from external sources (e.g., Coinbase and Binance) 108, and via RMQ 122. The service can choose a price on the basis of the index price. Periodically (e.g. every X seconds) the price will get fed to the engine 136. The price from all perpetual value calculations can be used. The price feed will also have a timestamp. The engine 136 can choose to consider exchange fee prices for calculation using the timestamp (e.g. the timestamp is too old).

The trading engine 136 can include, for example, the dispatcher package 138, the market-maker package 142, the marginer package 144, the matcher package 140, the price processor 150, the config package 148, and the accountant package 146. These are example components of the engine 136.

### Example Workflow

In example embodiments, an order may follow the following workflow.

### Intake 124:

An order can be received by Intake 124 from RMQ 122, where pre-validations and enrichment can be performed.

### IPC 134/Sequencer 132:

If the order is successful, intake 124 can publish it to IPC 134/Sequencer 132 bus, where it can get stamped with a sequence number.

Engine 136 may refer to a trading engine herein. Further, trading engine 136 integrates or interacts with a risk engine 152 and a matching engine 154.

The order can then be picked up by the engine 136 with a simple dispatcher (in the dispatcher module 138). Dispatcher 138 is a router that routes the order, or other requests, to an order executor or respective request executors, where more business validations can be performed. Once the order is validated in the order executor, it can send the order to an order processor, where it can get enriched with maxFee (maker or taker) to be charged. Then the order executor can send the order to a spot accountant (e.g. Accountant 146), where the order can be checked to see if it requires borrowing. Where borrowing is required, the spot accountant can call a margin processor (under the marginer module 144) for auto borrowing of USDC. Auto borrowing can credit borrowed asset (USDC) to spot account of the trading account. Then order executor can send the order to Central Limit Order Book (CLOB) matching engine under the matcher module 140. The matching engine can check liquidity inside CLOB and the automated market maker under market maker module 142. Once required liquidity is verified, the same quantity can be executed against CLOB and automated market maker. Fills (e.g., Trade or Execution) can be received in dispatcher OMS driver under the Matcher module 140. Fills can be processed by a fills processor and then the final settlement can happen in the spot accountant in USDC. Fills, order updates, account updates and position updates can then be published back to IPC 134 from the engine 136.

### Exhaust:

All the events can be picked up by exhaust (e.g., exhaust events 126, exhaust market data 128, and exhaust ledger 130). The messages can then be transformed into flat buffer format and sent down to RMQ 122. Microservices 110 and FIX engine 102 can consume the messages from RMQ 122 and can send it to the end client via REST, Websocket and FIX APIs.

While real-time execution is happening, scheduled triggers can be sent for the following:

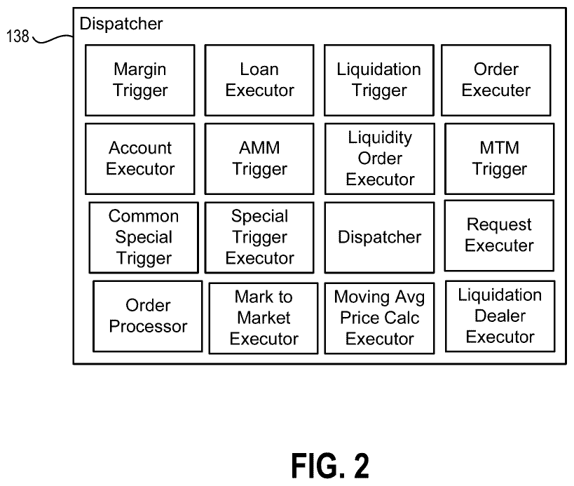

MTM PnL (Frequency, e.g., 5 mins): This may be responsible for calculating mark-to-market PnL. The trigger can be processed by a mark to market executor under the dispatcher module 138. See also MTM Trigger in FIG. 2 for example. The calculation can happen inside a perpetual processor under the marginer module 144.

Moving Avg Price (Frequency, e.g., 1 sec): This may be responsible for calculating mark price and funding rate. The trigger can be processed by a moving average price calculator executor under the dispatcher module 138. The calculation can happen inside a price data processor 150.

Liquidation (Frequency, e.g., 30 sec): This may be responsible for checking risk and triggering liquidation. The trigger can be processed by a liquidation dealer executor (see also Liquidation Trigger in FIG. 2) under the dispatcher module 138. The calculation can happen inside a liquidation dealer and a risk calculator under the marginer module 144.

Settlement (Frequency, e.g., 1 hour): This can be responsible for AMM perpetuals distribution, funding calculation, auto loan repayment and settlement. The trigger can be processed by a special trigger executor under the dispatcher module 138. The calculation can happen inside a perpetuals processor under the marginer module 144.

### Example Modules

FIG. 2 shows a schematic diagram of a dispatcher package 138, according to some embodiments.

The dispatcher package 138 can route commands and data to different execution paths and/or different components. The dispatcher package 138 can include different components such as: the margin trigger, the loan executor, the liquidation trigger, the order executor, the account executor, automated market maker trigger, the liquidity order executor, the MTM trigger, the common special trigger, and the special trigger executor.

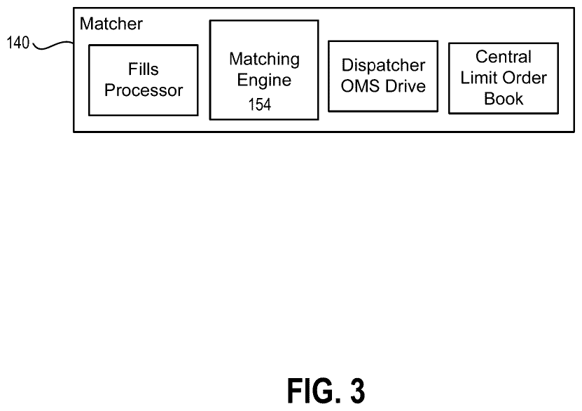

FIG. 3 shows a schematic diagram of a matcher package 140, according to some embodiments.

The matcher package 140 includes a matching engine that can execute transactions (e.g., an order match).

The matcher package 140 can include different components such as: the fills processor, the matching engine, the dispatcher OMS drive, and the central limit order book.

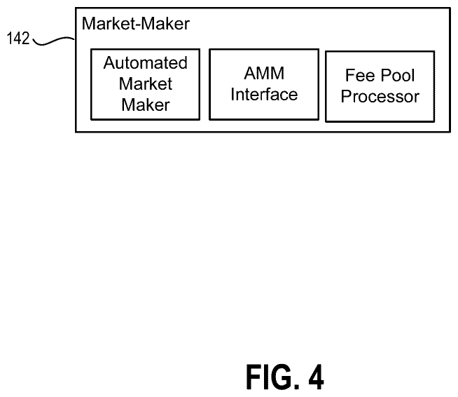

FIG. 4 shows a schematic diagram of a market-maker package 142, according to some embodiments.

The market-maker package 142 can generate and manage prices and quantities for the markets. The market maker can be an automated market maker (AMM). The market-maker package 142 receives inputs from the dispatcher 138 and the matcher package 140 and consists of the automated market maker, the AMM interface, and the Free Pool Processor.

The AMM can communicate with a perpetual processor of the marginer 144 when an account deposits liquidity in the automated market maker for perpetuals in a certain price range (e.g. Alice has 25% liquidity, to fulfill order against the liquidity bucket it may be short by some amount of currency, then Alice will be 25% of that short position, e.g., $1 then 25 cents).

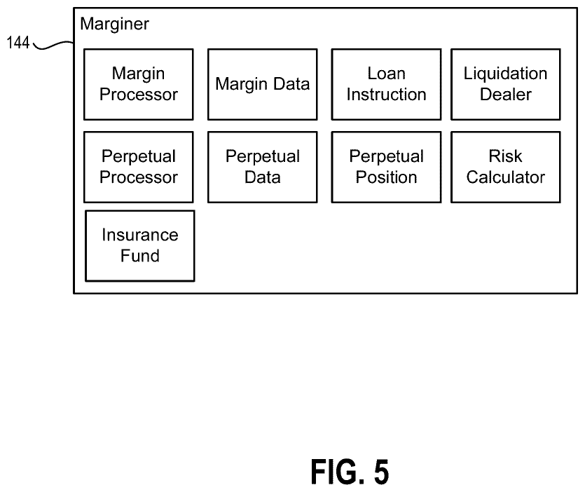

FIG. 5 shows a schematic diagram of a marginer package 144, according to some embodiments.

The marginer package 144 manages and stores all levered trading product components (e.g., perpetuals positions, perpetuals orders, perpetuals AMM instructions, margin lending and borrowing), risk management (e.g., the risk engine), and related data. The marginer package 144 receives inputs from the dispatcher package 138 and the accountant package 146, and outputs to the sequencer 132. The marginer package 144 can include different components such as: the marginer processor, the margin data, the loan instruction, the liquidation dealer, the perpetual processor, the perpetual data, the perpetual position, the risk calculator, and the insurance fund.

The perpetual processor can manage all the perpetual positions (e.g., there may be multiple positions and the perpetual processor can manage these different positions). In some embodiments, the perpetual processor may include the following example functions: handleMarkToMarket, handle Funding, handleSettlement, and onFill. The handleMark ToMarket function can, for example, look at an average price that has been traded at and current market price. Whatever the user loses or gains can be put in all the accounts (e.g., calculate profit and loss based on price movement). The handleFunding function may ensure that positive funding matches the negative funding. The handleSettlement function can go through all the accounts and look at profit metrics. Some will have negative profit and some positive profit. This should add to 0 (e.g., long quantities should match up to the short quantities). There may also be 3 macroeconomic checks to ensure the calculations are correct.

In some embodiments, the perpetuals data may include the following example functions: <Long, PerpetualPosition> and perpetualPosition.

In some embodiments, the perpetual position can include the following example functions: tradingAccountld, marketld, quantity, notational, fundingPnl, mtmPnl, settlementAssetld, reportedMtMPnl, and reportedFundingPnl.

In some embodiments, the margin processor (per asset) can include the following example functions: addLoan (LoanInstruction), removeLoan (Loanld), emoveLoanBook<loanOrder>, borrowLoan (qty, tradingAcctld), repayLoan (qty, tradingAccld), and calculatateInterest( ).

In some embodiments, the margin data (per asset) can include the following example functions: loanInstructions<loanld, LoanInstruction>, borrowers<trading Acctld>maintain insertion, totalLoanLocked, and totalLoanAvailable.

In some embodiments, the loan instruction can include the following example functions: loanld, available (toLend, long), locked (already borrowed, long), interestEarned, and iouAllotted.

In some embodiments, the risk calculator (unified) can include the following example functions: calculateRiskOnNewOrder( ) calculateRiskOn Transfer( ) calculateRiskOnWithdraw( ) calculateRiskonWithdraw, and calculateRiskOnAmml( ).

In some embodiments, the liquidation dealer can include the following example functions: checkSolvency (NBV/NCV)(which may loop around a borrowed book and perpetual positions), get unified risk and check in which liquidation level the account is falling into, send margin call, partialLiquidation (10% of borrowed value and 10% of perpetuals position), fullLiquidation (100% of borrowed value and 100% of perpetuals position), Defaulted/ADL, sendAccFreezeRequest, sendCalcelRequests, sendLiquidationOrder (IOC, with qty 20% of position, or qty that make is solvent).

In some embodiments, there may be different levels of solvency (debt, collateral, etc.) depending on the ratio (how much collateral relative to the liability). The liquidation dealer may be configured to send a liquidation order to buy some debt. The Auto-deleveraging (ADL) may be configured to prevent sending an liquidation order on a position. Instead the ADL may force a user to close the position by closing an opposite position (e.g., closing a long position to resolve a short position). ADL unwinds the position by selling, for example, BTC, and another user may do the opposite (e.g., forcing someone who is going short) to reduce both positions.

Insurance fund may be a mix of different assets. At the time that default insurance would step in, instead the insurance fund can step in to pay the owed profit to settle the position. Insurance fund may be owed by the debtor (specific amount of a specific currency), if they pay it back then the funds may go into the fund for later use.

The system may be configured to find counterparties that have rolled over unsettled profits owned by the insurance fund to give the funds to the unsettled loss owner at the time of settlement if the insurance fund has money then it can be used to settle the positions with the insurance funds assets to pay the unsettled profits.

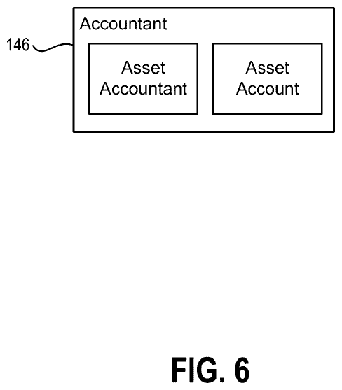

FIG. 6 shows a schematic diagram of an accountant package 146, according to some embodiments.

The accountant package 146 can implement accounting related functionalities. The accountant package 146 can generally be customized to each account within the system 100. The accountant package 146 can include different components such as: the asset accountant and the asset account. The account package may receive inputs from the config package 148, the matcher package 140, the dispatcher package 138, the marginer package 144, the market-maker package 142, and the price processor package 150. The accountant package 146 receives inputs and outputs to the margin processor when a lender is lending, a borrower is borrower, or a repayment is being made. The accountant package 146 also receives inputs and outputs to the liquidation dealer as a solvency check.

In some embodiments, the asset accountant can include the following example functions: credit( ) each variable, debit( ) each variable, fillsProcessor( ) borrow( ) lend( ) checkSolvency( ) calculateMarginRatio( ).

In some embodiments, the asset account can include the following example functions: available (long), locked (long), loaned (long), borrowed (long), iou (long), uoi (long), activeAvailable( )(max (a-b, 0), activeBorrowed( )(max (b-a, 0), netColValueInRefCcy 0 ((activeAvailable( )+locked)*price*weight), netBrrValueInRefCcy 0((activeBorrowed( ) price).

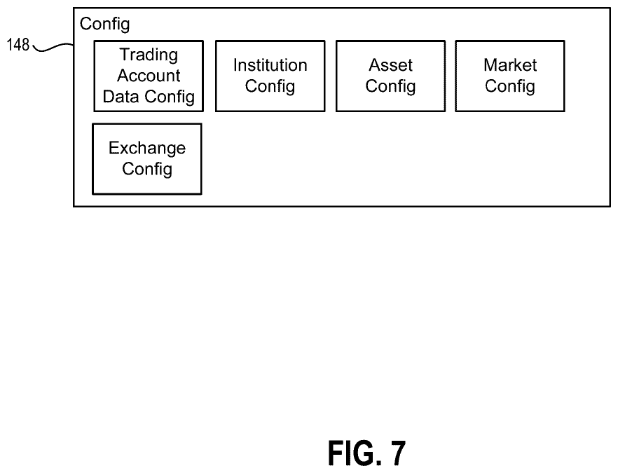

FIG. 7 shows a schematic diagram of a config package 148, according to some embodiments.

The config package 148 generally provides inputs to control the configurations of the account, assets, exchanges, institution, and markets. The config package 144 can include different components such as: the trading account data config, the institution config, the asset config, the market config, and the exchange config.

In some embodiments, the trading account data config can include the following example functions: maxInitialLeverage, makerFee, takerFee, isPrimaryAccount, isBorrowing, isLending, borrowedValue, collateralValue, InitialMarginRequirement, defcon0MarginRequirement, defcon1MarginRequirement, defcon2MarginRequirement, and defcon3MarginRequirement.

In some embodiments, the institution config can include the following example functions: parentld and maxInitialLeverage.

In some embodiments, the asset config can include the following example functions: maxBorrowQty, interestRateRatio, collateralWeight, and (BG/CTRL).

In some embodiments, the exchange config can include the following example functions: maxInitialLeverage, defconOLeverage, defcon1Leverage, defcon2Leverage, defcon3Leverage, perpsDefconOLeverage, perpsDefcon1Leverage, perpsDefcon2Leverage, perpsDefcon3Leverage, maxOpenAmmInst, maxOpenLoans, maxOpenOrder, and minLoanAddition.

In some embodiments, the market config can include the following example functions: marketld, overridePrice, minOrder, maxOrder, roundingCorrectionFactor, tickSize, liquidityTickSize, priceBuffer, marketType, statusCode, base, quote, and Fee.

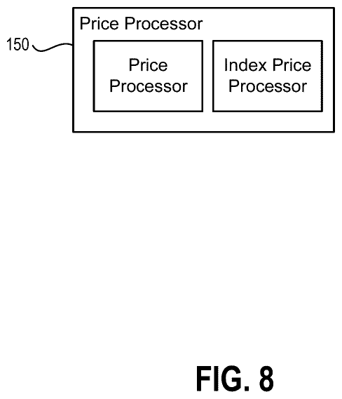

FIG. 8 shows a schematic diagram of a price processor package 150, according to some embodiments.

The price processor package is configured 150 is responsible for calculating and providing the different prices for the system (e.g., the mark price, the index price, the market price).

The price processor package 150 can include different components such as: the price processor and the index price processor.

In some embodiments, the price processor (per market) can include the following example functions: market, lastTradePrice, markPrice, and ammCurrentPrice.

In some embodiments, the index price processor (per asset) can include the following example functions: asset, indexPrice.

In operation, the exchange platform 100 of FIG. 1 may send order instructions to the engine 136 from FIX 102 and Order Entry Services 104 on the RMQ 122 into intake 124. The intake 124 may send the data into the sequencer 132 (e.g., to provide with a universal identifier) and send into the engine 136 through the IPC Bus 134. The dispatcher 138 may dispatch orders (e.g., buying and selling through the order executor), liquidity orders, account executors which may all be requested with the sequencer 132.

The systems shown herein may share description and variations and be compatible with the system as is described in U.S. patent application Ser. No. 18/793,679, entitled COMPUTER SYSTEM FOR ON-DEMAND MARGIN BORROWING AND LENDING, filed 2 Aug. 2024, and U.S. Provisional Patent Application No. 63/517,320, entitled COMPUTER SYSTEM FOR ON-DEMAND MARGIN BORROWING AND LENDING, filed 2 Aug. 2023, each of which are incorporated herein by reference.

The order executor of the dispatcher 138 may send order requests into the matcher 140. The matcher may send requests to the market maker 142 and the price processor 150. The system 100 may estimate how much collateral the user needs for the order and lock in the fees relating to the perpetuals and check to see if the user has enough collateral for the perpetuals order (e.g., a solvency check).

### Example Characteristics of Possible Perpetual Contracts

The exchange platform 100 may list markets for perpetual contracts with specific characteristics. A non-limiting example of such characteristics can include the following:
Underlying Market: Selected from popular digital assets, priced in USDC
Valuation: 1:1(linear) with respect to the Underlying Market
Settlement Period: 1 hour
Funding Period: 1 hour
Trading Hours: Continuous (excluding maintenance)
Expiry: None (Perpetual)
Settlement Asset: Initially USDC
Contract Multiplier. 1×
Maximum Initial Leverage: 10×
Liquidation Leverage: 20×

### Account Management and Trading

Users may use web applications (e.g., a REST API or a FIX API) to trade a perpetual market. To trade perpetual contracts on the exchange platform 100, users will be able to submit new orders and automated market making (“AMM”) instructions (e.g., through the AMM of Market-Maker 142) through the exchange platform's 100 sub-account management structure, called the “Unified Trading Account”.

A perpetual order sent for a trading account may be filled, partially or in whole. The account's position in a perpetual contract is the net of all its fills for that contract, with longs offsetting shorts.

### Overall Structure and Characteristics of Example Perpetual Contracts.

Overall structure.

Generally, users can open long and short positions by buying or selling multiples of 1 perpetual contracts in the relevant perpetual market on the exchange platform 100.

One long position can refer to buying 1 contract and each short position can refer to selling 1 contract. Fractional amounts may also be supported. Trading of perpetual contracts may lead to funding obligations depending on how the price of the Underlying Market moves relative to the perpetual market, which in turn may result in an obligation to settle on an hourly basis with the losing position(s) making a payment in the settlement asset to the winning position(s).

If there is insufficient amount of the relevant settlement asset in a user's trading account to make a settlement payment during the hourly settlement cycle, the system 100 may automatically borrow the asset through, for example, a margin service (e.g., marginer 144) to the extent the customer has sufficient margin. Therefore, to be eligible to trade in perpetual contracts, all users may also need to be eligible to access the margin trading services.

### Characteristics of Some Perpetuals Contract on the Exchange Platform 100.

### Contract Specifications.

There may be many different fields and/or data associated with a perpetuals contract. For example, some perpetuals contracts may include information some or all of the information in the following non-exhaustive list: expiration, contract name, underlying market, settlement asset, settlement period, funding period, contract size, contract multiplier, price tick, min/max order quantity, maximum initial leverage, liquidation leverage, acceptable collateral, index price, and trading/operating hours.

TABLE 1
Exemplary BTC Perpetual Futures

| Product Type | Linear Perpetual |
|---|---|
| Expiration | None |
| Contract Name | BTC/USDC-PERP |
| Underlying Market | BTC/USDC |
| Settlement Asset | USDC |
| Settlement Period | 1 hour |
| Funding Period | 1 hour |
| Contract Size | 1 BTC |
| Contract Multiplier | 1x |
| Price Tick | 0.1 USDC |
| Min/Max Order Quantity | 0.0005 contracts to 200 contracts in |
| | 0.00000001 increments |
| Maximum Initial Leverage | 10x |
| Liquidation Leverage | 20x |
| Acceptable Collateral | multiple |
| Index Price | As output by the index manager 106. |
| Trading/Operating Hours | Continuous (excluding maintenance) |

*different values for any and all of the above fields are within the teachings of this disclosure.

TABLE 2
Exemplary ETH Perpetual Futures

| Product Type | Linear Perpetual |
|---|---|
| Expiration | None |
| Contract Name | ETH/USDC-PERP |
| Underlying Market | ETH/USDC |
| Settlement Asset | USDC |
| Settlement Period | 1 hour |
| Funding Period | 1 hour |
| Contract Size | 1 ETH |
| Contract Multiplier | 1x |
| Price Tick | 0.01 USDC |
| Min/Max Order Quantity | 0.005 contracts to 600 contracts in |
| | 0.00000001 increments |
| Maximum Initial Leverage | 10x |
| Liquidation Leverage | 20x |
| Acceptable Collateral | multiple |
| Index Price | As output by the index manager 106. |
| Trading/Operating Hours | Continuous (excluding maintenance) |

*different values for any and all of the above fields are within the teachings of this disclosure.

### Underlying Markets.

An Underlying Market in a perpetual contract described herein refers to the Market of digital assets trading on the exchange platform 100 spot markets. Other digital assets that are not available for spot trading on the exchange platform 100 may also be used. The exchange platform 100 may also be limited to a few markets (e.g., BTC/USDC-PERP and ETH/USDC-PERP).

### Valuation.

A perpetual market's profit or loss can be one-to-one linear with respect to the Underlying Market's price movement. Thus 1 contract in a BTC/USDC perpetuals market may return the same USDC profit or loss as holding 1 BTC in a similar spot market would have.

### Funding.

All perpetual futures providers may use the concept of “funding” to ensure that the market price of the perpetual futures market may be correlated to the price of the Underlying Market of the given future. For example, the BTC/USDC-PERP market, driven by its own orderbook completely independent of all other markets, may nonetheless be correlated to the BTC/USDC market over the medium to long term. On the exchange platform 100 perpetuals market, this can be achieved as follows: 1) all the long position holders may make a payment (called “Funding Amount”) every, for example, hour quoted in a Settlement Asset to the short position holders when the Mark Price is higher than the Index Price; and 2) conversely, all the short position holders may pay a Funding Amount every, for example, hour to the long position holders when the Mark Price is lower than the Index Price.

“Mark Price” and “Index Price” are defined below. The exchange platform 100 may be orchestrated such that the sum of all fees paid may always equal the sum of all fees received.

On the exchange platform 100, the Funding Amount payable by one counterparty to another can be determined by the funding rate multiplied by the Notional Value of the position(s) held by each counterparty measured in the Settlement Asset (initially USDC):

Funding Amount(in USDC)=Funding rate×USDC Notional Value of position(s)

The funding rate can be calculated on an hourly basis and may be the relative excess of Mark Price over the Index Price, reduced in magnitude if necessary to, for example, ±1%, then further divided by, for example, 8:

Funding Rate=max(−1%,min((Mark Price−Index Price)/Index Price,1%))/8

### Index Price.

The Index Price can represent the exchange platform's 100 best understanding of the current consensus USD price of a given base asset of an Underlying Market across a number of regulated and/or high-volume exchanges (listed below), or another underlying source with an associated numeric value. The index price may be calculated by the Index Manager 106. The methodology may take a median of a number of external prices in addition to the exchange platform's current Index Price. Each asset may be individually assessed to determine which markets on which exchanges to use as inputs. When calculating the Index Price, input prices may be excluded if they are not deemed to be live or if they are deemed to have diverged (see Table 3) from the median of all input prices. The exchange platform 100 can then apply an exponentially weighted moving average, with a 20 second half life, to this final result.

TABLE 3
Example Divergence Thresholds

| TYPE | DIVERGENCE THRESHOLD |
|---|---|
| Tier 1 - Stablecoins (USDC, USDT) | +/−1% |
| Tier 2 - BTC, ETH | +/−5% |
| Tier 3 - All other | +/−10% |

The Index Price can be computed using an index manager 106 (more details below). The index managers 106 can provide real-time outputs from exchanges and markets to be used for calculations by the index managers 106. The index manager 106 can convert different sources of currencies into USD. The index manager 106 may be configured to remove slow sources and/or slow assets, calculate the median, remove outliers, smooth the data and output the price value. The index manager 106 can be configured to output values in, for example, USDC (so that the index manager 106 can output prices for all assets) Other output values are possible. The inputs can include the last published pricing (which may be input for the next calculation).

The index manager 106 may also provide a quality score. The index manager 106 may use its best guess (and the confidence score may indicate the quality of the guess) and then it is up to the recipient to define what is an acceptable quality/confidence.

The index manager 106 may also come up with a market-wide volatility of the price.

In some embodiments, a BTC index may have a dependency on USDC and USDT. In some embodiments, an ETH index may have a dependency on BTC, USDC, USDT. Other assets may have their own dependencies.

### Mark Price.

The Mark Price can represent a view of the current price of the perpetuals market on the exchange platform 100 with some additional logic to increase the costs of market manipulation by unethical participants. The methodology can take an exponential weighted moving average, with a 20 second half life, of the last traded price, updated every second.

### Settlement.

In order to ensure the continued functioning of fair and orderly markets, and to reduce overall systemic risk, an hourly settlement mechanism can be implemented on the exchange platform 100 using the marginer 144. Settlement may be in use at digital asset exchanges and, in the context of Perpetual trading, refers to the regular debits and credits made from/to the Trading Accounts of the losing and winning positions respectively. The settlement process on the exchange platform 100 may aim to realise profit and losses to the extent it is possible. It may differ from settlement in a traditional futures market, which might only happen at expiry of the contract.

The exchange platform 100 settlement system can enforce all mark-to-market profits or losses, plus all Funding Amounts, to be debited from or credited to the position holders' accounts (specifically to their balance of the settlement asset) at regular intervals, to the extent possible. This can reduce overall systemic risk mostly because more frequent settlements reduce the likely size of profits or losses over the period, which in turn reduce the values that might be unable to be paid in a worst case scenario. There can be other lesser benefits to the participants, such as being able to access profits from an open position since those profits will be automatically credited to their account.

During settlement the following example actions can be implemented by system 100:

1. All positions may be marked to market: this means that the system can calculate the profit or loss due to the change in the Mark Price (as defined above) since the most recent of the last settlement or the position open.

2. All Funding Amounts can be calculated using the method described above.

3. Each position's mark-to-market profits or losses (1) and the Funding Amount (2) can both be added to that position's current unsettled profit or loss, such as from partially or fully closing positions during the hour. This can determine the net amount of settlement asset (i.e. USDC).

4. Each position may therefore have an unsettled (net) profit that may need to be credited to or an unsettled (net) loss that may need to be debited from the trading account's spot balance in the settlement asset before the next settlement cycle begins.

5. First, the exchange platform 100 can apply all the losing positions' effects as follows:
a. When a position has an unsettled loss the system may first attempt to debit the trading account's available spot balance (if any) then may attempt to borrow the residual amount from available loan offers on the Exchange on a first-come first-served basis (if any) using the Margin service.
b. If there is still a residual unsettled loss, that may be increased by the “delayed settlement fee” described below, and kept until the next settlement cycle.
c. The sum of all such unsettled losses before their delayed settlement fees were applied, across all trading accounts, if any, may be the “unpaid settlement balance”—the amount that would ideally have been settled but could not be. The sum of unsettled losses including the additional delayed settlement fees can be called the “unpaid settlement balance plus fees”.

6. Second, the exchange platform 100 can apply all the winning positions' effects as follows:
a. each position's profit can be reduced from P to Y; and
b. the trading account's Available Balance can be credited by (P-X);
c. where X is that winning position's prorated share of the “unpaid settlement balance” (if any) and Y is that winning position's prorated share of “unpaid settlement balance plus fees”. Y can be kept as an unsettled profit until the next settlement cycle and can be displayed in the trading account as such.

7. Note that the total amount debited from the losing trading accounts (including the amounts borrowed by them) may exactly match the total amount credited to the profitable trading accounts, ensuring that all Available Balances can be fully backed in custody at all times.

8. Note that after the settlement calculations have completed, for each of the contracts, the sum of all unsettled profits may exactly equal the sum of all unsettled losses.

9. Note also that due to the volatile nature of markets, a trading account can easily have a net loss in one cycle and a net profit in the next.

The delayed settlement fee can be the equivalent of the interest that would have been charged if the unsettled loss could have been borrowed through the Margin service. In order to reduce the amount of residual unsettled loss, which may not be favourable to the winning positions, and to incentivise the losing positions to settle in full, we charge a higher interest rate than the Margin facility. Currently an interest rate of 2 times the current Margin borrowing rate can be charged, where there can be an active lending market, or 50% APR where there may not be. This can be subject to change with notice. Even though the rate is expressed as an APR the amount charged is per hour, using the compounding formula. Thus:

$$delayed settlement fee = unsettled loss * ( power ( 1 + APR , 1 / ( 365 * 24 ) ) - 1 )$$

In a future product enhancement, if a trading account starts a settlement cycle with an unsettled loss (e.g., due to being unable to borrow) then the exchange platform 100 can use an automated mechanism similar to a liquidation engine (e.g., used in Margin) to convert some assets currently being used as collateral into the settlement asset, by trading on the exchange platform 100. Such partial liquidation of assets may not incur the same additional fee that use of the liquidation engine does when liquidating for risk reasons.

### Account Management and Trading.

### Unified Trading Account.

Under the Unified Trading Account structure, users can have multiple trading accounts within their overall account/relationship with the exchange platform 100 (e.g., stored with the accountant 146). Each of their trading accounts under the same relationship can be fully independent of the others. A user can access all available products (i.e. spot trading, Margin trading service and perpetual contracts) through one trading account.

Each trading account may have its own balances, which can contribute to that specific trading account's collateral, and its own debts (positions) backed by the same collateral. Said differently, user trading accounts can be monitored independently by the risk/liquidation engine. Meaning, a liquidation that takes place in trading account 1 may have no direct impact on assets residing in trading account 2. In addition to spot trading and Margin service, perpetual positions can be added to each trading account, backed by the same collateral covering Margin trading in both spot and perpetual markets.

This strict separation of risks within individual trading accounts can help various users segments in different ways. For instance a broker can use different trading accounts for each of their own users and be confident that each of their user's assets will be kept separate and no contagion can occur, e.g. from a Default. Alternatively, a proprietary trading house can allocate funds to individual internal teams using separate trading accounts and be confident that even if one team suffers an unexpected situation the other team can continue their operations at all times.

### Entering and Exiting Perpetual Positions.

Users can buy or sell the desired quantity (number of contracts) on the appropriate Perpetuals market. A “long” position can be denoted with a positive number of contracts and a “short” position can be denoted with a negative number. Closing a position may be synonymous with holding no (zero) contracts.

For instance a customer might buy 5 contracts, making their position long 5 contracts (+5). If they subsequently sell 2 contracts this is functionally equivalent to reducing their position by 2, and their net position is now long 3 contracts (+3). Selling an additional 10 contracts at this point may close their long 3 contract position and enter a new short 7 contract position (−7).

Users are able to use the same order types that they are familiar with from trading spot markets at exchange platform 100 to also trade on perpetual markets, including limit orders, market orders and stop orders.

### Borrowing.

The introduction of unified accounts, required for perpetuals, may not impact borrowing.

However in addition to the current “borrow-to-trade” workflow, perpetual positions may also be able to “borrow-to-settle” (when needed) as discussed above. This means that a user trading perpetual markets may not need to manually ensure there is sufficient balance of that perpetual market's settlement asset in order to trade or to settle (i.e. initially USDC). The user may simply need sufficient collateral to be able to borrow the settlement asset at the end of the settlement period. Therefore, in order to be eligible for trading in perpetuals, a user may also be required to be eligible to use Margin and their trading accounts must have margin trading enabled in order to be allowed to trade perpetuals.

### Lending.

Lending may be carried out similarly to a system which, for example, implements margins.

### Fees.

Perpetual market trading fees can be charged in the settlement asset based on the Notional Value of that trade, converted to the settlement asset. A perpetual market may have a different maker and/or taker fee to the underlying spot market (if there even is one).

### Risk Management.

### Unified Risk Management.

Perpetual positions may be liabilities that potentially require some amount of Margin to support the position. Perpetual orders and perpetual AMM Instructions may also be liabilities that potentially require additional Margin to avoid being rejected up front or cancelled later by the risk management system. Perpetual positions' unsettled profits or losses may impact the risk calculations. Finally, spot debts may also be included in the same calculations. The risk management can be handled by a risk engine within the marginer 144 (e.g., the risk calculator).

### Margin Requirements.

### Types of Margin.

The Unified Trading Account may be configured to use leverages so that different risk levels for different products can be tracked and enforced. System 100 evaluates risk by comparing Margin to various Margin Requirements.

Margin may be defined as the current collateral value minus the current “debt” (both values measured in USD). Here debt can be defined as the sum of amounts borrowed by the trading account using the Margin service plus any perpetual positions' unsettled losses.

In some embodiments, may be defined as margin=(collateral-haircut)+futures pnl-debt.

Note that since the Margin and the various Margin Requirements may indirectly depend on Notional Values, which in turn may depend upon constantly varying market prices, all these values can be recalculated at least every, for example, 30 seconds to determine what status the account is in and therefore whether any actions need to be taken (such as liquidation, etc.).

### Margin Requirements.

There can be different Margin Requirements for different risk levels. If the Margin value is greater than the given Margin Requirement value, then the account may have sufficient Margin for that purpose. However if Margin is less than a given value, the account status may be updated correspondingly and actions will be taken (e.g. unwinding of derivative positions). Example margin requirements include an initial margin requirement, a warning margin requirement, a liquidation margin requirement, a full liquidation margin requirement, a defaulted margin requirement.

While the user can see the specific USD amounts for the multiple Margin Requirements, a more simplified view can be presented for their easier understanding. This can be called the Unified Trading Account's “Health”.

TABLE 4
Different exemplary account health indicators.

| Account Health | Description | Formula |
|---|---|---|
| Healthy | No risk | Initial Margin Requirement ≤ 0 |
| Healthy | Acceptable risk | Margin > Initial Margin Requirement |
| Monitor | Unable to increase | Margin ≤ Initial Margin Requirement and |
| | risk | Margin > Warning Margin Requirement |
| Caution | Margin call | Margin ≤ Warning Margin Requirement and |
| | | Margin > Liquidation Margin Requirement |
| Danger | Partial Liquidation | Margin ≤ Liquidation Margin Requirement and |
| | | Margin > Full Liquidation Margin Requirement |
| Critical | Full Liquidation | Margin ≤ Full Liquidation Margin Requirement |
| | | and Margin > Defaulted Margin Requirement |
| Suspended | ADL & Default | Margin ≤ Defaulted Margin Requirement |

Table 5 shows possible actions taken when the account's Margin is less than the given Margin Requirement can be seen. We have listed the Margin Requirements in order of decreasing USD value, which corresponds to increasing risk.

TABLE 5
Exemplary actions taken if Margin is less than required.

| Margin Requirement | Action(s) taken if Margin is less than the requirement |
|---|---|
| Initial Margin | Any attempt by the user to reduce the Margin below this value |
| Requirement | can be rejected. This corresponds to the “Max Initial Leverage” |
| | of 3x used in the existing Margin borrowing service. |
| | Margin can be reduced when new liabilities are added or |
| | collateral is reduced. These actions may have that effect and |
| | are therefore subject to rejection for exceeding initial margin: |
| | Submitting limit orders |
| | Submitting AMM Instructions |
| | Withdrawing or transferring funds from the trading |
| | account |
| | Aside from rejecting certain user actions, no other actions may |
| | be taken in this state |
| Warning Margin | If the trading account's Margin value reaches this value or lower |
| Requirement | then the user may be warned of their increased risk of |
| | liquidation, using email or other previously agreed mechanisms. |
| Liquidation Margin | If the trading account's Margin value reaches this value or |
| Requirement | lower, the liquidation engine can attempt to improve (increase) |
| | the Margin by trading on the user's behalf according to |
| | automated rules. |
| Full Liquidation Margin | If the trading account's Margin reaches this value or lower, it |
| Requirement | can cause the liquidation engine to follow the “Full Liquidation” |
| | logic. |
| Defaulted Margin | If the Margin reaches this value or lower, the liquidation engine |
| Requirement | may seek to move this trading account into a Defaulted state. If |
| | necessary it may need to unwind derivative positions or auto- |
| | deleverage (ADL) any open perpetual positions before using |
| | the existing Margin logic for the defaulted spot borrows. |

The system can recompute all of the above Margin Requirements at a regular interval or as necessary as described above and makes them available to clients via API or the web application.

### Margin Requirement Leverages.

TABLE 6
Exemplary leverage requirements.

| | | Perpetuals |
|---|---|---|
| Margin Requirement | Spot Leverage | Leverage |
| Initial Margin Requirement | 3x | 7x |
| Warning Margin Requirement | 5x | 11x |
| Liquidation Margin Requirement | 6x | 15x |
| Full Liquidation Margin Requirement | 12x | 25x |
| Defaulted Margin Requirement | 30x | 40x |

### Calculating Margin Requirements for a Trading Account.

Every liability may contribute to the trading account's various Margin Requirements. Those liabilities may include: debts (assets borrowed via the exchange platform 100 service), perpetual positions, perpetual limit orders, perpetual AMM Instructions and unsettled perpetual losses. In order to calculate a given margin requirement the type of requirement (are we calculating Initial Margin or Liquidation Margin?) and the type of product (spot or perpetuals) needs to be understood. This combination can give a specific leverage value, such as 3× for spot initial margin requirement, or 20× for perpetual liquidation margin requirement.

The Margin Requirement for an individual liability can be the Notional Value of the risk (measured in USD) divided by (Leverage-1). So a debt with a Notional Value of $100 at leverage 3× may have a margin requirement of $100/(3-1)=$50. A long or a short perpetual market position considered in isolation with a Notional Value of $100 at leverage 10× may have a margin requirement of $100/(10-1)=$11.

### Calculating Total Margin Requirement for a Trading Account.

To determine a specific Margin Requirement for the account the Spot Margin Requirements (using that requirement's spot Leverage) and the Perpetual Margin Requirements can be added up across all contracts (using that requirement's perpetual Leverage), both of which are explained next.

### Calculating the Spot Margin Requirement for a Trading Account.

This may simply be the sum of the individual Margin Requirements for all Borrows that the account has. This can include any potential Borrows from unsettled P&L.

### Calculating the Perpetual Margin Requirement for a Trading Account.

The trading account's Perpetual Margin Requirement can be the sum of the individual perpetual Margin Requirements, for all contracts.

To determine the perpetual margin requirement for a given contract the worst case scenario can be considered from an “up only” and a “down only” perpetual market move with the trading account's current position in that contract as the starting point.

In the up-only scenario the result may be the current position minus all short order quantities minus all AMM Instruction short quantities, and this net quantity can be priced at the maximum of (i) the Mark Price, (ii) all of the trading account's limit orders' prices and (iii) all of the Trading Account's AMM Instructions' upper bound prices.

In the down-only scenario the result may be the current position plus all long order quantities plus all AMM Instruction long quantities, and this net quantity can be priced at the current Mark Price.

Whichever of these two values, denominated in the Underlying Market's quote asset, is largest in absolute terms may be the worst-case perpetuals position that should be re-denominated in USD by multiplying by the current Index Price for the quote asset, and then divided by (leverage-1) to determine the overall perpetuals margin requirement for that contract.

All spot and perpetual margin requirements can be added together to determine the final current margin requirement for that trading account for that purpose at that time.

Impact on Margin Requirements from Perpetual Positions' Unsettled P&L.

Every perpetual position may have an “unsettled P&L”, denominated in the settlement asset for the given position's contract. The unsettled P&L can be a combination of unsettled profits or losses arising from market price movements, from realised trading profits or losses, and also from Funding Amounts, accrued since the last settlement. Unsettled P&L can be netted by settlement currency, making a single value for the whole trading account per settlement asset (e.g. a single USDC adjustment). Net unsettled profits can increase collateral value exactly as if they were added to the account's Available Balance, while net unsettled losses can reduce the account's Available Balance by as much as is available, and if that is still insufficient, can behave just like a Borrow of the settlement asset for the residual amount.

### Unwind Derivative Positions or Liquidation.

The exchange platform 100 can unwind derivative positions or liquidate accounts (e.g., Unified Trading Accounts) using the liquidation dealer of the marginer 144. Orders may be sent by the liquidation dealer to the Order Book and if such an order receives a fill an additional fee can apply for the use of the engine.

As mentioned elsewhere, Trading Accounts under the Unified Trading Account structure can be completely independent of each other from a risk consideration. Thus liquidation also only applies to a given trading account considered in isolation from all other trading accounts, including from any other trading accounts held by the same customer. “All limit orders”, for instance, refers to all limit orders in the trading account being liquidated. The same applies to “AMM Instructions”, “debt value”, etc.

### Liquidation (Partial).

During liquidation the system may follow the following procedure (running the same logic every, for example, 30 second liquidation cycle) with respect to the account being liquidated:

1. Cancel all open spot orders and all open perpetual orders (if any)

2. Terminate any one open AMM Instruction (either perpetual or a spot AMM Instruction) chosen randomly, if any are open

3. Convert, for example, 10% of debt value to USDC* via limit orders in spot markets at index price of, for example, ±1%, trading the highest collateral-rated assets first

4. Reduce open perpetual positions by, for example, 10% via limit orders at mark price of, for example, ±1%

5. Use whatever, for example, USDC is available at that time to repay any open loans on a pro-rata basis

### Full Liquidation.

During full liquidation the following procedure may be followed:

1. Cancel all open spot orders and all open perpetual orders (if any)

2. Terminate all open AMM Instructions in parallel, if any are open

3. Convert, for example, 100% of debt value to, for example, USDC via limit orders in spot markets at index price of, for example, ±3%, trading the highest collateral-rated assets first

4. Close all open perpetual positions via limit orders at mark price of, for example, ±3%

5. Use whatever, for example, USDC is available at that time to repay any open loans on a pro-rata basis

### Auto-Deleverage and Default.

When a trading account is at the Defaulted Margin Requirement state, the liquidation engine can take the following steps with respect to that account before that account is allowed to go into Default under the existing Default process of the Margin service:
to terminate any open AMM Instructions; and
then auto-deleverage all open perpetual positions.

Auto-deleveraging (“ADL”) may be required when an account has a position that cannot be unwound on the market despite offering an attractive price (“DEF Account”). This can happen for any number of reasons, including simply that all potential counterparties have not yet noticed the opportunity. When this happens the exchange platform 100 finds one or more potential counterparties who currently hold the opposite position (e.g., they are long when this account is short) and then it “auto-deleverages” them by forcing them to unwind enough of their positions, at the current Mark Price (the “ADL Position Counterparties”). The exchange platform 100 will choose the positions(s) with the biggest ratio of Initial Margin to Margin, which corresponds to the most levered accounts, and force those to unwind. This methodology may be updated.

During ADL, “unwind” can mean to reduce the ADL Counterparty(s)′ position sizes and adjust their unsettled P&L exactly as if they had been waiting in the market with a maker order at the given Mark Price before the liquidation engine forced the higher leveraged account to send a taker order. Note that, since the liquidation engine sent the taker order on behalf of the DEF Account, the DEF Account can pay the standard taker fee plus an additional liquidation fee. ADL maker orders (i.e. the trading accounts being auto-deleveraged) do not pay this fee. Also, since in this situation the DEF Account does not have a balance of the settlement asset, the exchange platform 100 may use the current Index Price to convert the value of the liquidation fee from the settlement asset into another asset that the DEF Account does hold, and charge that fee instead.

If the DEF Account also has an unsettled loss (e.g., is obligated to debit its account by the given amount of the settlement asset at the next settlement cycle) then the system can choose certain accounts in the method described immediately below (the “ADL Profit Counterparties”) and can reduce their unsettled profit(s) by the same total amount as DEF Account's unsettled loss. These unpaid settlement amounts are still owed by the DEF Account holder to ADL Profit Counterparties and later, if and when the DEF Account debts are fully repaid, the ADL Profit Counterparties can finally receive their unpaid profits using exactly the same process as repayment of spot loans after a Default.

The method for choosing the ADL Profit Counterparties may be updated. The methodology may be that:
All accounts with an unsettled profit for the given contract can be divided into two groups: (A) those whose positions have the opposite side to the DEF Account and (B) those who are flat.
Positions with the same side as the DEF Account may not be taken into account in the ADL process.
Then the DEF Account's unsettled loss can be offset against counterparties from set (A) in decreasing order of the amounts=(their unsettled profits divided by their absolute position size) x (their Initial Margin divided by their Margin).
If the DEF Account still has an unsettled loss, to further offset this, counterparties can then be chosen from set (B) in decreasing order of unsettled profit.
At no point may any counterparty's unsettled profits be reduced below zero.

Once ADL has completed, the liquidation engine may send the DEF Account into Default according to the Default process under the Margin service.

### Automated Market Making (AMM) Instructions.

### Creation.

Creation of perpetual market AMM Instructions may be functionally similar to spot market AMM Instructions as carried out by market-maker 142. However where the spot market may require a value or an amount of an underlying source (or base asset) and an amount of the quote asset to be specified and locked up (dependent on the parameters chosen by the user, and the system logic), the perpetual market AMM Instruction asks the user to specify how many more contracts they are prepared to buy and/or sell on top of whatever their current underlying perpetuals position is—the equivalent of sending a number of limit orders for the perpetual market. Just like sending multiple buy and sell limit orders, a perpetual market AMM Instruction may also have a margin requirement.

In addition, whereas assets deployed to and bought/sold by a spot AMM Instruction may be kept quite separate from the other assets in your trading account, any fills received as a result of open perpetual AMM Instructions may adjust the given trading account's position for the given contract.

For example, if a user:

(1) started with no position at all in, for example, BTC/USDC-PERP, then
(2) created an AMM Instruction in BTC/USDC-PERP, and then
(3) the market subsequently moved down causing the AMM Instruction to automatically buy some contracts, the user would see that they are now long BTC/USDC-PERP in your trading account. The AMM Instruction caused you to buy these contracts.

Other points of note:
Multiple AMM Instructions can be open at the same time and their effects are cumulative.
Once an AMM Instruction(s) automatically buys or sells contracts and causes a user's trading account's position to be long or short, it can behave as if that position had been manually entered by trading directly (i.e. via Ul or API). Therefore, standard Margin Requirements may apply to that position and profits and losses may accrue from that position, both from market movements and from Funding Amounts.

### Termination.

Similar to some spot market AMM Instructions, perpetual market AMM Instructions can be terminated at any time. Terminating a perpetual market AMM Instruction may simply reduce the Margin Requirement and may guarantees that AMM Instruction will not impact your position in the future.

Note that the trading account's position may be unaffected when the AMM Instruction is terminated. In the example above (e.g., where the user was flat, created an AMM

Instruction and the market moved down causing the user to buy contracts) terminating the AMM Instruction at that point could mean that those contracts may still be held and may still have a margin requirement for that position, etc.

### Margin Requirements (Risk).

An AMM Instruction can be regarded as a number of buy and sell limit orders at specific prices and quantities following predefined logic. Each of those limit orders can have its own Margin Requirement and the AMM Instruction's Margin Requirement may simply be the net of all those individual orders′.

Effectively then, if an AMM Instruction at a particular price has the potential to go short (sell) an additional S contracts between the current price and the AMM Instruction's upper bound U, and also has the potential to go long (buy) an additional L contracts between the current price and the AMM Instruction's lower bound K, then for the Margin Requirement the entire AMM Instruction can be represented as two simple limit orders: short S contracts at U price and long L contracts at the Mark Price.

### Exchange Remuneration.

Every time an order sent by a perpetual market AMM Instruction receives a fill it can be deemed to have a “model profit”. The model profit can be denominated in the perpetual contract's settlement currency and can equal half of the bid-offer spread of the AMM Instruction multiplied by the Notional Value of the fill at that time, plus the taker fee paid by the liquidity taker. The “AMM Instruction revenue” can be a portion of all model profits, for example, 25% for spot markets and 10% for perpetual markets, that can be paid by AMM Instruction submitters to the Exchange in return for using the AMM. Noting that a unified trading account may not have any USDC directly available at any given time, the system accounts for AMM Instruction revenues by treating each new fill's model profit as an unsettled loss for the AMM Instruction sender and as a corresponding unsettled profit for the exchange platform 100 itself. The standard settlement mechanism can be used to facilitate such debits (from the user's account) and credits (to the the exchange platform's revenue account) at the end of the current settlement cycle.

Further details of AMM instructions are provided in U.S. provisional patent No. 63/635,984 entitled COMPUTER SYSTEM AND METHOD FOR VIRTUAL MARKETS filed Apr. 18, 2024, the entire contents of which is hereby incorporated by reference.

In an aspect, embodiments described herein provide a computer system 100 for perpetual futures. System 100 connect with a plurality of user devices having an interface for the system, the user devices associated with user accounts that are unified trading accounts, each user trading account having code enabling derivative transactions, the code controlling operations for the derivative transactions comprising one or more derivative or perpetual positions, wherein code defines a derivative as a smart contract for futures without an expiry date that references an underlying source of numeric value.

The system 100 has a processing system that includes one or more processors and one or more memories coupled with the one or more processors, the one or more memories storing instructions for a trading engine 136, a risk engine 152 and a matching engine 154. The trading engine 152 for managing perpetual trading of the user accounts by detecting permissions for derivative trading that govern operations for a respective user account. The risk engine 152 automatically computing margin and margin requirements for the user account and estimates of expected liquidity cost for unwinding derivative positions. The risk engine 152 triggers automatic unwinding of derivative positions based on an acceptable level of risk or overrides. The matching engine 154 having a hybrid order book integrated with an automated market maker. The computed margin and liquidation cost reflects a quality of the assets in the customer account based on determining, for each type of assets in the customer account, a quality rating for a respective type of the asset in the customer account as an assessment of volatility or market risk of the asset in the customer account and an ability to liquidate the asset in the customer account. The computed margin and liquidation cost are adapted to change proportionally with a value of the assets in the customer account;

A perpetual package includes a perpetual processor, and the perpetual positions of the user accounts. Each of the perpetual positions are associated with margin and margin requirements for the user account and the estimated expected cost of liquidation which are recomputed by the system 100 at intervals or as necessary. Code automatically controls trading activities for the customer accounts operating in the trading mode using continuously computed estimates of margin and margin requirements for the user account and the estimated expected liquidation cost for the customer accounts.

The system 100 has an index manager to compute a numeric value for each underlying that is referenced by a perpetuals contract. The system 100 receives input from the interface for an order request for trading a perpetual market to buy or sell a desired quantity of perpetual contracts on the appropriate market, wherein a long position is denoted with a positive number of contracts and a short position is denoted with a negative number of contracts, wherein closing a position is synonymous with holding no perpetual contracts.

The system 100 generates output for an account interface of one or more visual elements relating to the perpetual positions of the user accounts for transmission to respective interfaces of the user devices and displays the visual elements relating to the perpetual positions at the interfaces of the user devices.

In some embodiments, the system 100 sets one or more margin requirements for the customer accounts, and continuously compares margin values for the customer accounts to the margin requirements and expected liquidation cost to automatically evaluate risk for the customer accounts, wherein the processor controls the trading activities for the customer accounts operating in the transaction mode using the one or more margin requirements.

In some embodiments, the system 100 computes a health indicator for a respective customer account based on the margin, the margin requirements, and the expected liquidation cost, the health indicator corresponding to one or more permitted actions for the customer account, wherein the computer system executes code to control activities for the customer account using the one or more permitted actions corresponding to the health indicator for the customer account.

In some embodiments, upon determining that the margin values for the customer account do not meet the margin requirements for the customer account, the system 100 updates the one or more permitted actions for the customer account, wherein upon receiving a request for an activity for a customer account, the system 100 verifies the one or more permitted actions corresponding to the health indicator for the customer account before implementing the requested activity, wherein upon determining that the requested activity is not include in the one or more permitted actions corresponding to the health indicator for the customer account, the system 100 rejects the request for the activity for the customer account.

In some embodiments, the margin requirements comprise an initial margin requirement, a warning margin requirement, a liquidation margin requirement, a full liquidation margin requirement, a defaulted margin requirement.

In some embodiments, the system 100 computes margin values for the assets in the customer account used as collateral for the trading activities by discounting a normalized value of all types of assets in the customer account by a haircut reflective of a quality measure of the assets in the customer account, wherein a higher quality asset will have a higher rating and lower haircut, and a lower quality asset will have a lower rating and higher haircut.

In some embodiments, the system 100 computes margin values for the assets in the customer account as collateral value-haircut, wherein the collateral value is a normalized value of the assets in the customer account and a haircut reflects a quality measure of the assets in the customer account, wherein a higher rating reflects a lower haircut, and a lower rating reflects a higher haircut.

In some embodiments, the system 100 computes the margin for the customer account as: (collateral value-haircut)+futures pnl-debt.

In some embodiments, index manager creates new indices, edits parameters of the indices, publishes new indices, and freezes the indices.

In some embodiments, the interface has a user interface to display visual elements for the user accounts and the perpetual positions, wherein the user interface has a perpetual position blotter, portfolio pages, and historical pages.

In some embodiments, the interface has an application programming interface for the perpetual positions of the user accounts, wherein the application programming interface has a perpetual position API managing data about the perpetual positions for the user accounts, trading account configurations, and a ticker.

In some embodiments, the system 100 nets out each of the perpetual positions for each of the user accounts.

In some embodiments, the system 100 has a liquidation component to automatically unwind the derivative positions in the trading account.

In some embodiments, the underlying is an underlying asset.

In some embodiments, automated market maker is configured to discretize long and short positions; hold consolidated perpetual positions; and distribute the perpetual positions to components of the system.

### Definitions.

Available Balance (of an asset).

The unencumbered quantity of the given asset in a Trading Account which can be guaranteed to be backed in Custody and may be withdrawn immediately (subject to withdrawal limits and other standard safety checks). Other balances may be tracked, including the borrowed balance (obtained via the Margin service), the on-market balance (locked in limit orders, also fully backed by assets in custody but not able to be withdrawn) and the receivable balance (owed to customer after being counterparty to a default, and not backed by assets in custody).

### Borrow (an Asset).

Assets on the exchange platform 100 can be borrowed on-demand from the Margin service, assuming that there is sufficient lending capacity at the time and that the user has sufficient Margin to exceed the incremental Margin Requirement for that additional debt.

### Leverage.

Leverage can be a numerical indication of the extra trading power allowed for a given amount of collateral. The exchange platform 100 can use Leverage exclusively to determine the Margin Requirements for a given risk, planned or actual. The exchange platform 100 can use the more conservative Margin Requirement of reciprocal of (leverage minus one) versus some other systems which use the smaller, riskier, Margin Requirement of the reciprocal of the leverage. For a simple Borrow this definition also means that leverage is equal to collateral/Margin.

### Notional Value.

For the purposes of calculating Margin Requirements, Notional Value can be the USD equivalent value of the given debt, Position, etc. For spot markets the most recent Index Price can be used to convert an amount of any given asset to USD and for perpetual markets we use the most recent Mark Price, further converted from the settlement asset to USD using the Index Price if necessary.

For instance a debt of 3.1 ETH may have a notional value of 3.1 times the current.bxETH Index Price. Meanwhile a perpetual position of short 4 BTC/USDC PERP contracts may have a notional value of 4 times the current BTC/USDC PERP Mark Price times the current.bxUSDC Index Price.

Notional Values can also be re-denominated in other assets by dividing the standard USD Notional Value by the current Index Price of the desired denomination. For instance to convert a Notional Value of 100 USD to USDC you would divide 100 by the current. bxUSDC Index Price.

### Position.

Each Trading Account may have a Position in zero, one or more of the perpetual contracts that the exchange platform 100 can offer. Fractional positions may also be supported. A position may be long (equivalent to a positive quantity of contracts), flat (zero contracts) or short (negative contract count). For users' convenience, positions can be tracked both from the perspective of their actions (buying and selling) but also of settlement. Note that a flat position may yet have an unsettled profit or loss.

### Trading Account (or Unified Trading Account, Sub-account).

One of potentially multiple such accounts held as part of the single relationship that a user has with the exchange platform 100. Each account may be independent of the other, holding its own asset balances, own borrowings (via the Margin service) and own perpetual account positions. Trading Accounts may also separate for risk purposes, having individual Margin and Margin Requirement calculations. It may also be possible for one user to have two Trading Accounts, one of which is in Default and the other of which is unaffected and able to continue all actions as normal.

### Exemplary Margin Service Product Description.

The exchange platform 100 can provide margin borrowing and lending features using the marginer 144.

The marginer 144 may be designed to provide increased capital efficiency to users who lend their assets (“Lenders”) and for other users to access such funding (“Borrowers”) for their trading activities on the exchange platform 100.

Although it may be the Lender that bears the credit risk of the Borrower, the exchange platform 100 can provide a risk engine with strict risk controls, collateral monitoring and liquidation mechanisms. In some embodiments, the exchange platform 100 may implement a liquidation fund.

### Overall Structure.

In some embodiments, margin lending and borrowing functionality can allow fiat and digital currencies to be lent/borrowed for trading against collateral provided in fiat and digital currencies. The exchange platform 100 can create hourly loans which can be rolled over on an hourly basis at the new market-clearing interest rate at the end of each hour.

### Lending.

In some embodiments, the exchange platform 100 can set the Annual Percentage Rate (“APR”) for lending in each of the available currencies. If a Lender is satisfied with the APR, they can submit a loan offer specifying the asset type and amount they are willing to lend. The loan offer amount may need to be greater than, for example, US$5,000 in value which may be subject to change. In some embodiments, Lenders may be able to specify their preferred APR.

The exchange platform 100 can set risk controls, determine the lending APR for margin loans and any haircuts (which may be up to 100%) for collateral assets.

In doing so, the exchange platform 100 can take into account relevant factors, which may include the supply and demand of the specific asset on the exchange platform 100, the asset type, and the overall market condition for the specific asset. Based on these factors, the Exchange may increase or decrease the APR without advance notice to Lenders.

The term of loans on the exchange platform 100 can be one hour. As such, interest payments from Borrowers to Lenders can arrive mid-hour (borrower closes out position) or on-the-hour (as part of the hourly roll-over matching algorithm). Interest payments are automatically reinvested into the loan offer, causing compounding growth.

Termination of loans can be requested at any time, but if any part of the loan is being utilized by an active borrower, the termination request may be rejected. The Lender can be required to reach out to their Relationship Manager to request loan termination and the exchange platform 100 can provide the Borrower(s), for example, seven days' notice to repay their loans. Upon loan repayment by the Borrower(s), the Lender's loan can be terminated. If no part of the loan offer is being utilized then the entire loan offer (which automatically includes accrued interest) can be returned to the Lender's available balance immediately and the loan offer can be terminated.

### Borrowing.

In some embodiments, only eligible Borrowers (i.e. those that are institutional clients in eligible jurisdictions) can access marginer 144. If/When a user is deemed eligible for marginer 144, the user themselves then may have the ability to configure their account (per sub-account) with unique Maximum Initial Leverage values (e.g., 0-3x).

In some embodiments, marginer 144 loans can be provided, recorded and monitored on a sub-account level. Once the user has enabled marginer 144 for their sub-account(s), they can take advantage of a streamlined “Auto-borrow to trade” feature. Upon submission/execution of a margin enabled trade, the user can become a Borrower.

The term of marginer 144 loans can be one hour. When opening a new loan, the Borrower pays the first one hour of interest in advance with the exchange platform 100 deducting the first one hour interest from the Borrower's sub-account. The same process can happen for each subsequent hour in which the loan is open. No refunds may be made if loans are kept open for less than the full 1 hour increment.

Borrowers can pay an APR that is denominated in the same asset as the margin loan itself. These interest payments are made automatically from the sub-account that has the open borrow.

In some embodiments, the exchange platform 100 can provide Lenders with the ability to set their own desired minimum APR when making a loan offer, a more automated/streamlined loan closure process (on the Lender's side), utilize AMM Instructions as collateral and other enhancements.

### Risk Management.

Loan Assets.

In principle, each asset that is available on the exchange platform 100 may be lent and borrowed. In some embodiments, only USDC, BTC and ETH may be available for lending and borrowing. The exchange platform 100 can monitor systemic risk related to any asset and limit the total amount of borrowing for a specific asset.

### Collateral.

In some embodiments, collateral calculations may be specific (isolated) to a single sub-account (i.e. each sub-account can have a unique open borrow position).

In some embodiments, all assets in a user's sub-account can be considered as potential collateral to borrow assets in that sub-account. If a user borrows multiple assets in one sub-account, collateral assets can be cross-margined within the account.

In some embodiments, the exchange platform 100 may apply a haircut to certain assets which can be displayed to users. Haircuts on certain assets can be determined by the exchange platform 100 taking into account various factors, including but not limited to the volatility of the asset, liquidity of the collateral and the overall market condition of the asset.

The following assets can be considered as eligible collateral: 1) Available/idle assets in the relevant sub-account; 2) Assets on hold for limit orders (the exchange platform 100 can calculate the minimum of (i) the asset available to fill the limit order; and (ii) target asset at the limit price) 3) Assets on hold for AMM Instructions (similar formula to limit orders as AMM Instructions can be similar to multiple limit orders on the exchange platform 100 limit order book).

### Liquidation.

In some embodiments to minimise liquidations, the exchange platform may expect to: 1) allow only low maximum initial leverage (e.g., 3x); 2) use generally conservative collateral ratings; 3) limit the max borrowing size based on exchange platform 100 risk tolerance levels; 4) implement a risk engine which includes open order collateral.

All liquidations called out below take place on the exchange platform 100 Order Book.

Users may not be able to take actions that would cause their leverage to be greater than the maximum initial leverage (e.g., 3x).

If a user's leverage touches the Maintenance Leverage ratio (e.g., ≥5x), the exchange platform 100 can send a margin warning to the user. The user can start to receive alerts once per hour.

If a user's leverage increases further and reaches the Liquidation Leverage ratio (e.g., >6x), the exchange platform can: 1) partially liquidate the collateral, where the risk engine can aim to bring the leverage below this level; 2) use smaller order sizes to avoid liquidation cascades; 3) use external price references to avoid liquidation cascades; 4) liquidations fees may apply (e.g., fees can be 50 bps but may be configurable).

If a user's leverage continues to increase (e.g., ≥12×), the exchange platform can attempt to liquidate the user's entire position using more aggressive trades and prices. Liquidation fees can continue to apply.

If a user's sub-account leverage increases to, for example, 30×, that sub-account can be deemed to be in default. The exchange platform 100 can suspend the user's specific sub-account and to the extent assets in the user's sub-account may be insufficient to meet outstanding debts, the Borrower may remain liable for any outstanding debts. The Borrower may then be required to either request the exchange platform 100 to take control of the assets in the user's sub-account equal in value to the debt outstanding at the time of the default, transfer assets from another sub-account or deposit the shortfall onto the exchange platform 100. Upon full repayment of the loan, the exchange platform 100 can lift the sub-account suspension and the user will be able to resume trading again if desired.

For each process that requires the exchange platform to liquidate a user's assets, the user can bear the fees related to such liquidation, such as trading fees incurred. If a user's sub-account is in a state of liquidation, the exchange platform 100 can limit certain activities from taking place for that specific sub-account. The client may be required to resolve the liquidation state by transferring asset balances from another sub-account or by depositing new assets in the sub-account.

### Index Manager 106.

Various components of our the exchange platform 100 may require accurate market pricing of assets that may or may not be listed on the exchange platform 100 market or if listed, the market may or may not have sufficient or recent enough trade volume to satisfy required confidence in pricing.

In some embodiments, there may be an automated monitor in place that only pulls pricing from specific exchanges. In some embodiments, the exchange platform 100 may have no productionised, single-source of truth for the market price of assets/markets that are not actively trading on the exchange platform 100, nor may the exchange platform 100 have an alert system to inform when the market prices has diverged from those of external (competitor exchange) markets.

The manual process of sourcing, calculating, and recording the data presents an opportunity for human error. In addition, the ongoing burden to manually update the price results in a low degree of confidence that the data may be accurate. In some embodiments, the exchange platform 100 may not need to create an active spot market for assets underlying Perps/Futures. In some embodiments, the exchange platform 100 can access Price Indices (index=a (spot) price feed for a given asset sourced from various external and internal data providers/sources) and its historical data.

In some embodiments, the exchange platform 100 uses an index manager 106 to Use Cases.

The foreseeable use cases for an index manager 106 include (but are not limited to):
Determining a given subaccount's current margin ratio (or leverage) and therefore whether the position needs to be liquidated or not. During liquidation these prices can then also used to send liquidation orders into our internal markets in a way that may avoid some of the “price cascades”;
Providing up to date USD values;
Providing internal price cache to reference the case of exceeding low volume markets (ex. LTC/BTC);
Front-Back coordination and using the same single reference price. For example, 25% price checks for limit orders are currently build on a mixture of “last price” and “current price” which can be hard to coordinate between the front and back end;
AMM Instruction size limits;
Dynamic Asset Listing Process (INSTRUMENT and MARKET/AMM setup); and
Perpetual swaps.

### Impact.

The Index Manager 106 may enable futures, margin, and perps, reduce operational risk exposure do to current manual processes (decrease risk), enable market dislocation alerts and circuit breakers (decrease dislocation expenses), and enable reliable MARKET listing (decrease legal/compliance risk associated w/market launch).

### Security Considerations.

To enhance security associated with the index manager 106 and subsequent index feeds, the following may be included in the final design: source data from multiple providers (consisting of constituents/exchanges), control for single price source deviation, control for multiple price source deviation (control for events like “Mango Exploit”), control for faulty data provider availability/connectivity, ensure data is FROM the constituent data provider probably using connections over TLS

In addition to the above, best practices may be followed with regards to architecture and delivery of streaming data (consumed internally and potentially externally).

### Regulatory/Compliance Considerations

Index data can be used to support delivery of various regulated offerings (i.e. futures, margin lending). To that end, historical index data may need to be stored in a secure, accessible, and auditable format.

### Proposed Solution-Feature(s) and User Journey

Feature Set 1: Index Manager 106

In some embodiments, the Index Managers 106 may have the ability to create, edit, publish, and delete indexes. They will access the Index Manager 106 via CTRL 120. The interface may provide a turnkey experience that makes the parameterization as simple as possible.

An Index Manager 106 user may be able to create new indices, edit the various parameters of existing indices, publish new indices, pause/freeze new indices, archive an index, access the various actions above governed by your c-pod(s).

A CTRL administrator may be required to approve/sign the publishing of an index or the editing of any published index (including unpublishing/archiving).

Index states can include their status (e.g., active—the index can ingest data, calculate outputs, and be recorded in logs, and paused—the index may not be ingesting data, calculating outputs, and not recording in logs. Index states may include whether they are published (published—the API returns the last calculated data even if paused, this may also include auto updating supporting documentation, and not published/blank—the API errors out).

The Index Manager 106 Users may have an interface where it may addNewIndex, editIndex, publishIndex, pause/freezeIndex, index archiveIndex. This interface may include the ability to view, edit, or add the following information: Index Symbol, Asset, Constituent Data Sources, Permissible Deviation, Source Inactivity Tolerance (seconds), Asset Inactivity Tolerance (Seconds), Index Inactivity Tolerance (seconds), and EMA Half-Life (milliseconds).

The Index Symbol (e.g., dot, text characters upper and lower, underscore, dash, numerals) may be a blank field where a user can input the index symbol. The rules for the Index Symbol may be that it may be globally unique (e.g., a new index cannot be created with the same symbol as an existing index). It may have specific formatting (e.g., a prefix consistent with industry standards, the exchange, and the base currency). The form field input may be case insensitive. There may be a minimum and maximum character requirement.

The Asset can be provided in a dropdown list of all available assets from all constituent data sources. This list may be generated from a query of all constituents (e.g., triggered by addNewIndex or editIndex). Only a single asset may be selected. This field may not be stored, as it may only be used to help select the right constituent data sources.

The Constituent Data Sources may be a list of all available constituent data sources, filtered by selected asset. This list may be generated by polls of all constituents (e.g., triggered by addNewIndex or editIndex). A user may be able to select the constituent (e.g., “Binance”). A user may be able to select the constituent currency pair(s) offered by the constituent (e.g., “BTC/BUSD” and “BTC/USD”). Incoming Quality Score may also be provided based on this data which may validate to integers 0-10.

Permissible Deviation (%) may be the maximum percentage a given datum can deviate from the median of all data and NOT be filtered/removed from the final median calculation. This may be a float >0 and <100.

Source Inactivity Tolerance (seconds) may be a measure of whether the data provider has updated ANY DATA for ANY asset in the last x seconds. If not, then the exchange platform 100 may assume the last provided value for the target asset is no longer accurate and may not be used in the MEDIAN calculation. This can be an integer >0, initial value is 10 for all sources.

Asset Inactivity Tolerance (seconds) may be a measure of whether the data provider has updated data for the SPECIFIC ASSET in the last x seconds. If not, then the exchange platform 100 may assume the last provided value for the target asset is no longer accurate and may not be used in the MEDIAN calculation. This may be an integer >0. There may be different Inactivity Tolerance thresholds for each asset.

Index Inactivity Tolerance (seconds) may measure if the Index Manager 106 has updated data for the SPECIFIC INDEX in the last x seconds. If not, then the exchange platform 100 may assume the value is no longer valid and may not be used in the MEDIAN calculation. This may be an integer >0, global value, initial value 10. This can be an exchange-wide configuration (not per-index). This can be hard-coded and may not need to be editable via CTRL.

EMA Half-Life (milliseconds) may be the raw output value of the index and can be further smoothed by an Exponential Moving Average mechanism, with the given half-life. This can be an integer >0, global value, initial value 20,000. This can be an exchange-wide configuration (not per-index). This can be hard-coded and may not need to be editable via CTRL.

The logic used by the Index manager 106 in some embodiments may generally be as follows:

The “PRICE” ingested from the various Constituent Data Source providers may be the LAST TRADE PRICE (e.g., not bid, ask, hi, lo).

Price Calculation Methodology: Calculate DATA AVAILABILITY DRIVEN TRUNCATED MEDIAN price of all data sources.

Step 1: Check each constituent data source for denomination/quote currency.

Step 1.i: is quote currency USD? (If yes, then Step 1 completes; proceed to Step 2. If no, proceed to Step 1.ii). Step 1.ii: Is there a live index for the quote currency? “Live” in this situation may mean that the status is ACTIVE and the timestamp is more recent than Index Inactivity Tolerance. (e.g., if the data source is BTC/USDT do we have a USDT/USD index that is ACTIVE and the timestamp is not more than 10 seconds old?)(If yes, multiply incoming price value (that is denominated by non-USD) by the last calculated value of the identified active index; Step 1 complete. Proceed to Step 2. If no, do not include the constituent data source in calculations (Steps 4-6), log event in Exception Log, Step 1 complete; Proceed to Step 2).

Step 2: Check each constituent data source for compliance with Source Inactivity Tolerance (if not compliant, then remove it from the possible inputs for this calculation and log event in Exception Log(it should be re-evaluated in future calculations)).

Step 3: Check each constituent data source for compliance with Asset Inactivity Tolerance (if not compliant, it can be removed from the possible inputs for this calculation and log event in Exception Log(it should be re-evaluated in future calculations)).

Step 4: Check the liveness of the previously calculated Index Price (if the timestamp of this index's Index Price is more than Index Inactivity Tolerance time ago, it can be excluded from this round of calculations).

Step 5: Calculate median of all live sources (Sources 1 through n: most recent data from each constituent provider, if not excluded due to reasons given above. Source n+1: previous calculated Index Price, if not excluded due to step 4).

Step 6: Check each constituent data source (including the prior Index Price) for compliance w/Permissible Deviation (>x %, where x is a variable/parameter input). Log event in Exception Log if needed.

Step 7: Truncate data. Note that data that may be out of compliance with Asset Inactivity Tolerance, Source Inactivity Tolerance, or Index Inactivity Tolerance may have already been excluded by now. Remove/truncate any constituent source data (NOT INCLUDING the prior Index Price) that deviates from the calculated median by more than the Permissible Deviation %.

Step 8: Calculate a Truncated Median. (This is the “Raw Index Price”).

The result should then be rounded to 5 significant figures. By request, one such implementation is:

// Return the given value rounded to the given number of significant digits
define sigfigs(value, digits) {
let div = pow(10, floor(log10(value))+1-digits);
return round(value / div) * div;
}

Step 9: Smooth the Raw Index Price to derive the final Index Price. Either a prior Index Price (and timestamp) is available for this Index, or it is not. If a prior Index Price is not available, the exchange platform 100 may assume the prior timestamp is the Epoch (1970-01-01 00:00) and the prior price is zero. At this time elapsedMillis milliseconds have passed since the last update (elapsedMillis=current time-prior timestamp)

Let

$$retain = power ( 0.5 , elapsedMillis / EMAHalfLifeMillis )$$

Let

$$smooth = retain * prior Index Price + ( 1 - retain ) * Raw Index Price$$

The final result

$$Index Price = sigfigs ( smooth , 5 )$$

Step 10: Calculate Confidence Score. Sum the maximum possible Constituent Quality Score (the manually recorded score from each data source provider). Only external data sources and the exchange platform's markets can count toward the possible Constituent Quality Score. Specifically, the previous Index Price (listed as source “n+1” in step 4) may not be included in the Constituent Quality Score calculations. Currently the diagram is incorrect because it includes a quality score for the previous Index Price.

Sum the relevant Constituent Quality Score for each constituent currency pair that was included in the STEP 6 calculation. Divide maximum possible Constituent Quality Score (Step 9.i.) by the relevant Constituent Quality Score (Step 9.ii.) This can be the Confidence Score of the Index Price at the given price timestamp.

The Constituent Quality Score may be determined as follows:

1. The score is an integer between 1 and 10, where 1 represents the lowest quality and 10 represents the highest quality.

2. The initial value of each data source is 10 assuming the data source is perfect. The score is calculated by applying a point-deduction based rule.

3. On day 1, the platform credibility and market trading volume are taken into consideration. More credible platforms with larger trading volume will lead to fewer points deduction, thus higher score.

4. The following rules are used to factor in exchange credibility
a. Coinbase: 0 points deducted
b. Binance: 1 point deducted
c. Other exchanges: 2 points deducted

5. The following rules are used to factor in market trading volume: (Date source: Coinmarketcap)
a. Market 24 hr trading volume >10%, 0 points deducted
b. Market 24 hr trading volume between 5% and 10%, 1 point deducted
c. Market 24 hr trading volume between 1% and 5%, 2 points deducted
d. Market 24 hr trading volume <1%, 3 points deducted

### Feature Set 2: Index Details

In some embodiments, Index Managers 106 may be able to look up incoming constituent data sources for a given index. Index details may, for example, include: the constituent data source/provider (i.e. exchange), the constituent currency pairs, the Constituent Quality Score for each currency pair, and the maximum possible Constituent Quality Score for the index. Index.

### Feature Set 3: Manage Constituent Data Source Providers

In some embodiments, constituent data providers may be added or removed from the Index Manager 106. Use constituent data provider's rest endpoint may provide a list of assets they support. This may ensure that the data is polled and refreshed any time addNewIndex or editIndex is user. For example, prior to removing a data source provider, the individual indices using it may be updated by the Index Manager 106 Users.

### Feature Set 4: Exchange Platform Index API

In some embodiments, the exchange platform 100 may be able to access various index feeds. All indices should be updated at least once per second (if there has been a change in any input value). The following data may be required by dependent internal systems: endpoint 1—calculated index prices, calculated confidence scores, and timestamps for all published indices; endpoint 2—all indices constituent sources, assets supported, and timestamps; endpoint 3—calculated index price, calculated confidence score, and timestamps for specific indices. These may be accessible by snapshots updated every second, streaming real-time feed, etc. These values may be accessible internally or by users.

### Feature Set 4: Logging

In some embodiments, the exchange platform 100 may log of all calculations (including inputs and timestamps), all outgoing data, exception reports for each time a parameter triggered removal of a data source from a calculation (permissible deviation, source inactivity tolerance (seconds), asset inactivity tolerance (seconds)) by the system 100. In some embodiments, the logs may, for example, be accessible by CTRL 120. In some embodiments, the logs may not be accessible by CTRL, but retrievable on demand. The logs may be stored for a predefined amount of time (e.g., 1-2 years). The logs may be privately held or publicly available.

### Feature Set 5: Exchange Platform Constituent Documentation

In some embodiments, documentation that describes the data sources and the weightings may be available. In some embodiments, historical charting may also be available.

### Feature Set 6: Override Price

In some embodiments, the index manager 106 may be configured to accept PUSH requests to override a particular index to a particular price and a PUSH request to turn off the override later. Such functionality may assist in testing edge cases or for other similar testing purposes.

### Implementation Details.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein

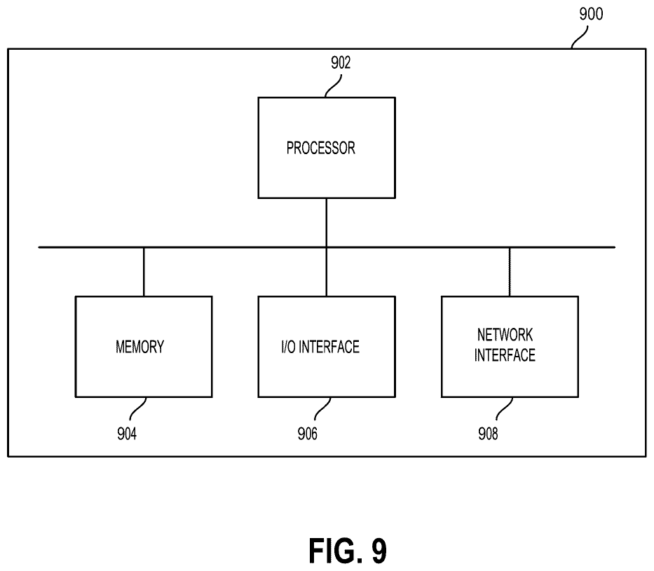

FIG. 9 is a schematic diagram of a computing device 900, exemplary of an embodiment. As depicted, computing device 900 includes at least one processor 902, memory 904, at least one I/O interface 906, and at least one network interface 908.

For simplicity only one computing device 900 is shown but system may include more computing devices 900 operable by users to access remote network resources and exchange data. The computing devices 900 may be the same or different types of devices. The computing device 900 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Each processor 902 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 904 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 906 enables computing device 900 to interconnect with one or more input devices, such as a keyboard, mouse, camera, touch screen and a microphone, or with one or more output devices such as a display screen and a speaker.

Each network interface 908 enables computing device 900 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 900 is operable to register and authenticate users (using a login, unique identifier, and password for example) prior to providing access to applications, a local network, network resources, other networks and network security devices. Computing devices 900 may serve one user or multiple users.

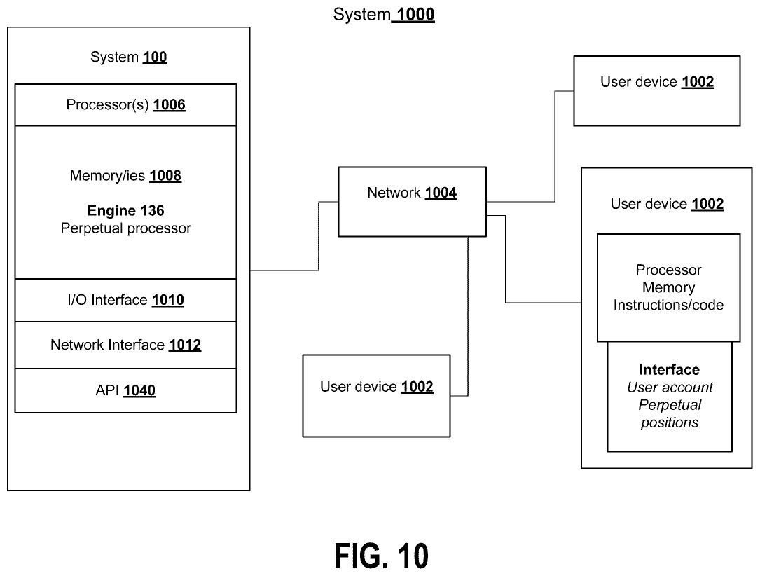

FIG. 10 is a schematic diagram of an example embodiment of a distributed computer system 1000 for perpetual futures. The distributed computer system 1000 can include the system 100 of FIG. 1A and FIG. 1B, for example.

The distributed computer system 1000 has a plurality of user devices 1002 having interfaces. The user devices 1002 connect to a processing system via network 1004 connections. The user devices 1002 are associated with user accounts. Each user account has one or more perpetual positions. A perpetual is a contract for futures without an expiry date that references an underlying source of numeric value. There can be different types of numeric values. The system 1000 can convert the numeric values into asset prices or the prices of digital assets, for example.

The distributed computer system 1000 has a processing system (e.g. system 100) that includes one or more processors 1006 and one or more memories 1008 coupled with the one or more processors 1006. The one or more memories 1008 store instructions for an engine 136 (e.g. risk engine) for managing perpetual trading of the user accounts by tracking collateral value and automatically liquidating collateral based on an acceptable level of risk. In some embodiments. The engine 136 has a matching engine having a central limit order book and an automated market maker.

The processing system has a perpetual package of a perpetual processor, data, the perpetual positions of the user accounts. See, for example, FIG. 5 of marginer 114. Each of the perpetual positions can be backed by collateral recomputed by the processing system at a regular interval or as necessary. The perpetual processor handles the perpetual logic outside of matching. The perpetual processor can implement market funding, settlement, and market price calculation.

In some embodiments, the processing system has an index manager to compute a numeric value for each underlying source (e.g. base asset) that is referenced by a perpetuals contract.

In some embodiments, the processing system receives input from the interface of a user device 1002 for an order request for trading a perpetual market to buy or sell a desired quantity of perpetual contracts on the appropriate market. In some embodiments, the long position is denoted with a positive number of contracts and a short position is denoted with a negative number of contracts. In some embodiments, a closing a position is synonymous with holding no perpetual contracts;

In some embodiments, the processing system generates output relating to the user accounts and the perpetual positions for transmission to an interface of a user device 1002 and displays visual elements relating to the perpetual positions at the interface of the user device 1002. The processing system has a communication bus with a sequencer to route data and commands to the engine 136.

In accordance with an aspect, there is provided a computer system 1000 for perpetual futures. The computer system 1000 includes a plurality of user devices 1002 having an interface for the system 1000 and a processing system 100 that includes one or more processors 1006 and one or more memories 1008 coupled with the one or more processors 1006. The user devices 1002 are associated with user accounts and each user account potentially having one or more perpetual positions. A perpetual is a contract for futures without an expiry date that references an underlying source of numeric value. The one or more memories 1008 storing instructions for a risk engine 136 for managing perpetual trading of the user accounts by tracking collateral value and automatically liquidating collateral based on an acceptable level of risk. The risk engine 136 has a matching engine 140 having a central limit order book and an automated market maker (e.g., in market maker 142). The processing system 100 has a perpetual package of a perpetual processor (e.g., in marginer 144), data, and the perpetual positions of the user accounts. Each of the perpetual positions are backed by collateral recomputed by the processing system 100 at intervals or as necessary. The processing system 100 has an index manager 106 to compute a numeric value for each underlying that is referenced by a perpetuals contract. The processing system 100 receives input from the interface for an order request for trading a perpetual market to buy or sell a desired quantity of perpetual contracts on the appropriate market. A long position is denoted with a positive number of contracts and a short position is denoted with a negative number of contracts. Closing a position is synonymous with holding no perpetual contracts. The processing system 100 generates output relating to the perpetual positions of the user accounts for transmission to interfaces of the user devices 1002 and displays visual elements relating to the perpetual positions at the interfaces of the user devices 1002. A communication bus 134 with a sequencer 132 routes data and commands to the risk engine.

In some embodiments, the index manager 106 creates new indices, edits parameters of the indices, publishes new indices, and freezes the indices.

In some embodiments, the interface has a user interface 112 to display visual elements for the user accounts and the perpetual positions. The user interface 112 has a perpetual position blotter, portfolio pages, and historical pages.

In some embodiments, the interface has an application programming interface 114 for the perpetual positions of the user accounts, wherein the application programming interface 114 has a perpetual position API managing data about the perpetual positions for the user accounts, trading account configurations, and a ticker.

In some embodiments, the processing system 100 nets out each of the perpetual positions for each of the user accounts.

In some embodiments, the processor system 100 has a liquidation dealer engine (e.g., in marginer 144).

In some embodiments, the underlying source is an underlying asset. In some embodiments, the underlying source is a base asset.

In some embodiments, the automated market maker is configured to discretize long and short positions, hold consolidated perpetual positions, and distribute the perpetual positions to components of the system.

FIG. 12 illustrates an example method 1200 for perpetual futures, according to some embodiments.

In accordance with an aspect, there is provided a computer implemented method for perpetual futures 1200. The method 1200 includes providing a processing system with an engine for managing perpetual trading of user accounts by tracking collateral value and automatically unwinding derivative positions or liquidating collateral based on an acceptable level of risk (block 1202), computing, by the processing system, collateral for the perpetual positions of the user accounts (block 1204), computing a numeric value for each underlying that is referenced by a perpetuals contract (block 1206), receiving input from an interface for an order request for trading a perpetual market to buy or sell a desired quantity of perpetual contracts on the appropriate market (block 1208), and generating output relating to the perpetual positions of the user accounts for transmission to interfaces of the user devices and display of visual elements relating to the perpetual positions at the interfaces of the user devices (block 1210). Each user account has one or more perpetual positions. A perpetual is a contract for futures without an expiry date that references an underlying source of numeric value. The risk engine has a matching engine having a central limit order book and an automated market maker. Each of the perpetual positions are backed by the collateral, and recomputing, by the processing system, the collateral at intervals or as necessary. A long position is denoted with a positive number of contracts and a short position is denoted with a negative number of contracts. A closing a position is synonymous with holding no perpetual contracts.

In accordance with an aspect, there is provided a non-transitory machine readable medium having stored thereon a plurality of instructions that, when executed by at least one computing device, cause the at least one computing device to perform the method for perpetual futures 1200. The method 1200 includes providing a processing system with an engine for managing perpetual trading of user accounts by tracking collateral value and automatically liquidating collateral based on an acceptable level of risk (block 1202), computing, by the processing system, collateral for the perpetual positions of the user accounts (block 1204), computing a numeric value for each underlying that is referenced by a perpetuals contract (block 1206), receiving input from an interface for an order request for trading a perpetual market to buy or sell a desired quantity of perpetual contracts on the appropriate market (block 1208), and generating output relating to the perpetual positions of the user accounts for transmission to interfaces of the user devices and display of visual elements relating to the perpetual positions at the interfaces of the user devices (block 1210). The risk engine has a matching engine having a central limit order book and an automated market maker. Each user account has one or more perpetual positions. A perpetual is a contract for futures without an expiry date that references an underlying source of numeric value. Each of the perpetual positions are backed by the collateral, and recomputing, by the processing system, the collateral at intervals or as necessary. A long position is denoted with a positive number of contracts and a short position is denoted with a negative number of contracts. A closing a position is synonymous with holding no perpetual contracts.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

As can be understood, the examples described above and illustrated are intended to be exemplary only. The scope is indicated by the appended claims.

What is claimed is:

1. A computer system for perpetual futures comprising:
a plurality of user devices having an interface for the system, the user devices associated with user accounts that are unified trading accounts, each user trading account having code enabling derivative transactions, the code controlling operations for the derivative transactions comprising one or more derivative or perpetual positions, wherein code defines a derivative as a smart contract for futures without an expiry date that references an underlying source of numeric value;
a processing system that includes one or more processors and one or more memories coupled with the one or more processors, the one or more memories storing instructions for a trading engine, a risk engine and a matching engine, the trading engine for managing perpetual trading of the user accounts by detecting permissions for derivative trading that govern operations for a respective user account, the risk engine automatically computing margin and margin requirements for the user account and estimates of expected liquidity cost for unwinding derivative positions, wherein the risk engine triggers automatic unwinding of derivative positions based on an acceptable level of risk or overrides, the matching engine having a hybrid order book integrated with an automated market maker, wherein computed margin and liquidation cost reflects a quality of assets in the user account based on determining, for each type of the assets in the user account, a quality rating for a respective type of the asset in the user account as an assessment of volatility or market risk of the asset in the user account and an ability to liquidate the asset in the user account, wherein the computed margin and liquidation cost are adapted to change proportionally with a value of the assets in the user account;
wherein the processing system has a perpetual package of a perpetual processor, data, the perpetual positions of the user accounts, wherein each of the perpetual positions are associated with margin and margin requirements for the user account and the estimated expected cost of liquidation which are recomputed by the processing system at intervals or as necessary, wherein code automatically controls trading activities for the user accounts operating in a trading mode using continuously computed estimates of margin and margin requirements for the user account and the estimated expected liquidation cost for the user accounts;
wherein the processing system has an index manager to compute a numeric value for each underlying that is referenced by a perpetuals contract; and
wherein the processing system receives input from the interface for an order request for trading a perpetual market to buy or sell a desired quantity of perpetual contracts on an appropriate market, wherein a long position is denoted with a positive number of contracts and a short position is denoted with a negative number of contracts, wherein closing a position is synonymous with holding no perpetual contracts;
wherein the processing system generates output for an account interface of one or more visual elements relating to the perpetual positions of the user accounts for transmission to respective interfaces of the user devices and displays the visual elements relating to the perpetual positions at the interfaces of the user devices; and
wherein a communication bus with a sequencer routes data and commands to the risk engine.

2. The computer system of claim 1, wherein the processor sets one or more margin requirements for the user accounts, and continuously compares margin values for the user accounts to the margin requirements and expected liquidation cost to automatically evaluate risk for the user accounts, wherein the processor controls the trading activities for the user accounts operating in the trading mode using the one or more margin requirements.

3. The computer system of claim 2, wherein the processor computes a health indicator for a respective user account based on the margin, the margin requirements, and the expected liquidation cost, the health indicator corresponding to one or more permitted actions for the user account, wherein the computer system executes code to control activities for the user account using the one or more permitted actions corresponding to the health indicator for the user account.

4. The computer system of claim 3, wherein upon determining that the margin values for the user account do not meet the margin requirements for the user account, the processor updates the one or more permitted actions for the user account, wherein upon receiving a request for an activity for a user account, the system verifies the one or more permitted actions corresponding to the health indicator for the user account before implementing the requested activity, wherein upon determining that the requested activity is not include in the one or more permitted actions corresponding to the health indicator for the user account, the computer system rejects the request for the activity for the user account.

5. The computer system of claim 1 wherein the margin requirements comprise an initial margin requirement, a warning margin requirement, a liquidation margin requirement, a full liquidation margin requirement, a defaulted margin requirement.

6. The computer system of claim 1, wherein the processor computes margin values for the assets in the user account used as collateral for the trading activities by discounting a normalized value of all types of assets in the user account by a haircut reflective of a quality measure of the assets in the user account, wherein a higher quality asset will have a higher rating and lower haircut, and a lower quality asset will have a lower rating and higher haircut.

7. The computer system of claim 1, wherein the processor computes margin values for the assets in the user account as collateral value-haircut, wherein the collateral value is a normalized value of the assets in the user account and a haircut reflects a quality measure of the assets in the user account, wherein a higher rating reflects a lower haircut, and a lower rating reflects a higher haircut.

8. The computer system of claim 1, wherein the processor computes the margin for the user account as:
$$( collateral value - haircut ) + futures pnl - debt .$$

9. The computer system of claim 1, wherein the index manager creates new indices, edits parameters of the indices, publishes new indices, and freezes the indices.

10. The computer system of claim 1, wherein the interface has a user interface to display visual elements for the user accounts and the perpetual positions, wherein the user interface has a perpetual position blotter, portfolio pages, and historical pages.

11. The computer system of claim 1, wherein the interface has an application programming interface for the perpetual positions of the user accounts, wherein the application programming interface has a perpetual position API managing data about the perpetual positions for the user accounts, trading account configurations, and a ticker.

12. The computer system of claim 1, wherein the processing system nets out each of the perpetual positions for each of the user accounts.

13. The computer system of claim 1, wherein the processor system has a liquidation component to automatically unwind the derivative positions in the trading account.

14. The computer system of claim 1, wherein the underlying is an underlying asset.

15. The computer system of claim 1, the automated market maker is configured to discretize long and short positions; hold consolidated perpetual positions; and distribute the perpetual positions to components of the system.

16. A computer implemented method for perpetual futures comprising:
managing perpetual trading of user accounts by detecting permissions for derivative trading that govern operations for a respective user account, a risk engine automatically computing margin and margin requirements for the user account and estimates of expected liquidity cost for unwinding derivative positions, wherein the risk engine triggers automatic unwinding of derivative positions based on an acceptable level of risk or overrides, wherein computed margin and liquidation cost reflects a quality of assets in the user account based on determining, for each type of assets in the user account, a quality rating for a respective type of the asset in the user account as an assessment of volatility or market risk of the asset in the user account and an ability to liquidate the asset in the user account;
recomputing, for each of the perpetual positions, margin and margin requirements for the user account and the estimated expected cost of liquidation which are by a processing system at intervals or as necessary, wherein code automatically controls trading activities for the user accounts operating in a trading mode using continuously computed estimates of margin and margin requirements for the user account and the estimated expected liquidation cost for the user accounts;
receiving input from an interface for an order request for trading a perpetual market to buy or sell a desired quantity of perpetual contracts on an appropriate market, wherein a long position is denoted with a positive number of contracts and a short position is denoted with a negative number of contracts, wherein closing a position is synonymous with holding no perpetual contracts;
executing code controlling operations for derivative transactions comprising one or more derivative or perpetual positions, wherein code defines a derivative as a smart contract for futures without an expiry date that references an underlying source of numeric value; and
generating output for an account interface of one or more visual elements relating to the perpetual positions of the user accounts for transmission to respective interfaces of user devices and displays the visual elements relating to the perpetual positions at the interfaces of the user devices;
wherein the margin requirements comprise an initial margin requirement, a warning margin requirement, a liquidation margin requirement, a full liquidation margin requirement, a defaulted margin requirement.

17. The method of claim 16 further comprising setting one or more margin requirements for the user accounts, and continuously comparing, using the processing system, margin values for the user accounts to the margin requirements and expected liquidation cost to automatically evaluate risk for the user accounts, wherein a processor controlling the trading activities for the user accounts operating in the trading mode using the one or more margin requirements.

18. The method of claim 17, further comprising computing a health indicator for generating visual elements at an interface corresponding to a respective user account based on the margin, the margin requirements, and the expected liquidation cost, the health indicator corresponding to one or more permitted actions for the user account, wherein the computer executes code to control activities for the user account using the one or more permitted actions corresponding to the health indicator for the user account.

19. The method of claim 18, further comprising, upon determining that the margin values for the user account do not meet the margin requirements for the user account, updating the one or more permitted actions for the user account, wherein upon receiving a request for an activity for a user account, the computer verifies the one or more permitted actions corresponding to the health indicator for the user account before implementing the requested activity, wherein upon determining that the requested activity is not included in the one or more permitted actions corresponding to the health indicator for the user account, rejecting the request for the activity for the user account.

20. A non-transitory machine readable medium having stored thereon a plurality of instructions that, when executed by at least one computing device, cause the at least one computing device to perform a method for perpetual futures comprising:
managing perpetual trading of user accounts by detecting permissions for derivative trading that govern operations for a respective user account, a risk engine automatically computing margin and margin requirements for the user account and estimates of expected liquidity cost for unwinding derivative positions, wherein the risk engine triggers automatic unwinding of derivative positions based on an acceptable level of risk or overrides, wherein computed margin and liquidation cost reflects a quality of assets in the user account based on determining, for each type of assets in the user account, a quality rating for a respective type of the asset in the user account as an assessment of volatility or market risk of the asset in the user account and an ability to liquidate the asset in the user account;
recomputing, for each of the perpetual positions, margin and margin requirements for the user account and the estimated expected cost of liquidation which are by a processing system at intervals or as necessary, wherein code automatically controls trading activities for the user accounts operating in a trading mode using continuously computed estimates of margin and margin requirements for the user account and the estimated expected liquidation cost for the user accounts;
receiving input from an interface for an order request for trading a perpetual market to buy or sell a desired quantity of perpetual contracts on an appropriate market, wherein a long position is denoted with a positive number of contracts and a short position is denoted with a negative number of contracts, wherein closing a position is synonymous with holding no perpetual contracts;
executing code controlling operations for derivative transactions comprising one or more derivative or perpetual positions, wherein code defines a derivative as a smart contract for futures without an expiry date that references an underlying source of numeric value; and
generating output for an account interface of one or more visual elements relating to the perpetual positions of the user accounts for transmission to respective interfaces of user devices and displays the visual elements relating to the perpetual positions at the interfaces of the user devices.
